(19) United States
(12) Patent Application Publication
(10) Pub. No.: US 2021/0276235 A1
(43) Pub. Date: Sep. 9, 2021

(54) INJECTION- OR COMPRESSION-MOLDED ARTICLES

(71) Applicant: SHPP GLOBAL TECHNOLOGIES B.V., Bergen op Zoom (NL)

(72) Inventors: Arunachala PARAMESHWARA, Bangalore (IN); Venkatesha NARAYANASWAMY, Bangalore (IN); Lingshan WANG, Shanghai (CN)

(21) Appl. No.: 17/260,060

(22) PCT Filed: Jul. 16, 2019
(86) PCT No.: PCT/IB2019/056078

§ 371 Date: Jan. 13, 2021

(30) Foreign Application Priority Data
Jul. 16, 2018 (EP) 18183793.1

(51) Int. Cl. B29C 45/14; B29C 43/18; B29C 70/68

(52) U.S. Cl. CPC B29C 45/14631; B29C 43/18; B29K 2105/206; B29C 70/688; B29C 45/14819

(57) ABSTRACT

Various embodiments disclosed relate to injection-molded or compression-molded articles. A method of injection molding or compression molding an article includes directing a shot of molten material into a mold cavity including a plurality of contacting substantially identical modular mesh parts to fill the mold cavity. The method also includes solidifying the shot of molten material to form the article including the plurality of modular mesh parts and the solidified shot of molten material. Various embodiments also provide parts machined from a block produced by various methods of injection molding or compression molding.

### BACKGROUND

Forming thick articles, such as having thicknesses greater than 10 mm, 30 mm, or greater than 50 mm, using conventional injection molding techniques is problematic due to physical defects in the material voids formed from volumetric shrinkage of molten material. Due to the high volumetric shrinkage rate of polymers, such volumetric shrinkage cannot be compensated for in thick articles during the packing phase even with very high packing pressure.

Rapid prototyping is a group of techniques used to quickly fabricate a scale of a physical part or assembly using three dimensional computer aided design data. One method includes machining a prototype part from a block of material (e.g., a quadrilateral or other polygonal-shaped block of polymeric material) using a computerized numerical control (CNC) machine. However, rapid formation of suitable blocks for machining, such as via conventional injection molding or compression molding techniques, is not practical due to physical defects in the material. Extrusion of rods can be used to form the block; however, such extrusion is generally limited to about 30 mm diameter. Although additive layer manufacturing (e.g., “three dimensional-printing” or “3D-printing”) can be used for form prototypes, this method is slow and forms materials that can suffer from poor mechanical properties.

U.S. Pat. No. 8,879,249 discloses forming reinforced enclosures for computing devices by providing an array of structural members and applying fibers to the structural members to form an internal frame and then injecting a material into a mold to encase the internal frame.

### SUMMARY OF THE INVENTION

In various embodiments, the present invention provides a method of injection molding or compression molding an article. The method includes directing a shot of molten material into a mold cavity including a plurality of contacting substantially identical modular mesh parts to fill the mold cavity. The method includes solidifying the shot of molten material to form the article including the plurality of modular mesh parts and the solidified shot of molten material. In various embodiments, the present invention provides an article formed by the method. In some embodiments, the method further includes machining the article to form a part. In some embodiments, the present invention provides the part formed by the machining.

In various embodiments, the present invention provides a modular plastic mesh part for injection molding or compression molding an article. The modular plastic mesh part includes a thermoplastic polymer, a thermosetting polymer, an elastomer, or a combination thereof. The modular plastic mesh part has a shape including a square-shaped planar grid including two substantially parallel opposing major faces. The shape includes through-holes running orthogonal to the two major faces. The shape includes a first set of parallel struts and a second set of parallel struts. The first and second sets of struts are perpendicular to one another and intersect throughout the modular plastic mesh part at junctions. The first and second sets of struts have an approximately uniform shape with a largest cross-sectional dimension that is approximately the same throughout the modular plastic mesh part. The junctions have an approximately uniform shape with a largest cross-sectional dimension that is approximately the same throughout the modular plastic mesh part. The junctions have a largest cross-sectional dimension that is about 50% to about 150% of a largest cross-sectional dimension of the struts. The junctions at the corners of the modular plastic mesh part further include interlocking features that are sufficient to interlock with corresponding interlocking features on one or more adjacent ones of the modular plastic mesh part in a layer or stack of the modular plastic mesh parts. The interlocking features can be such that facilitates rapid and easy connection of one modular mesh in a layer or stack to one or more adjacent modular mesh in a layer or stack. This enables formation of different shapes and sizes of molded articles.

Various embodiments of the present invention provide an injection-molded or compression-molded block that includes an embodiment of the modular plastic mesh part and a solidified material encasing the modular plastic mesh part and having the same or different composition as the modular plastic mesh part. Some embodiments of the present invention provide a machined part formed from the injection-molded or compression-molded block.

Various embodiments of the present invention provide a method of forming a part. The method includes forming a block including at least one shot of molten material solidified in contact with another solidified material using an injection molding or compression molding technique. The method includes machining the block to form the part. Some embodiments of the present invention provide the part formed by the method.

Various embodiments of the present invention provide a method of forming a part. The method includes forming a block. Forming the block includes directing a shot of molten material into a mold cavity including a plurality of contacting substantially identical modular plastic mesh parts to fill the mold cavity. Forming the block also includes solidifying the shot of molten material to form the article including the plurality of modular plastic mesh parts and the solidified shot of molten material. The method also includes machining the block to form the part.

Various embodiments of the present invention provide a method of forming a part. The method includes forming a block. Forming the block includes providing an injection molding or compression molding machine that includes a melt source of molten material, a mold defining a mold cavity, one or more gates in fluid communication with the melt source and the mold cavity, wherein the one or more gates collectively define a total orifice area, and a mold core movable relative to the one or more gates. Forming the block includes directing a first shot of molten material into the mold cavity through a first portion of the total orifice area while simultaneously occluding a second portion of the total orifice area with the mold core. Forming the block includes solidifying the first shot of molten material to form a first part of the block. Forming the block includes directing the mold core away from the one or more gates after the first part has been formed. Forming the block includes directing a second shot of molten material into the mold cavity through the second portion of the total orifice area while simultaneously occluding the first portion of the total orifice area with the first part of the block. Forming the block also includes solidifying the second shot of molten material to form a second part of the block. The method of forming the part also includes machining the block to form the part.

Various embodiments of the present invention have advantages over other injection molded or compression-molded articles, methods of forming the same, parts machined therefrom, and methods of making the same, at least some of which are unexpected. For example, in various embodiments, the present invention provides faster and easier production of injection-molded or compression-molded blocks, such as thick blocks. In various embodiments, the modular mesh part can be used to form blocks of various sizes more quickly and easily than conventional techniques. In various embodiments, the present invention can provide thick blocks with less or no formation of voids or sink marks, such as those due to volumetric shrinkage in blocks formed via other methods. In various embodiments, the present invention can provide thick blocks with good adhesion between molten material that solidifies in contact with other solidified material during formation of the block, providing material properties equal to, close to, or even exceeding that of solid blocks formed via other methods such as in a single shot.

In various embodiments, the present invention provides correspondingly faster and easier production of machined parts using the blocks, such as rapid production of prototype parts. In various embodiments, the present invention can provide a prototype part more quickly than additive layer manufacturing. In various embodiments, the present invention can provide a prototype part having better mechanical properties than additive layer manufacturing.

The present inventors have recognized, among other things, that traditional development product processes are relatively long and costly. Various embodiments of the present invention can help reduce the time and cost associated with traditional development processes by shortening the time needed to injection-mold a polymeric article and by enabling the injection molding or compression molding process to be performed on molding machines that are typically less costly.

Various embodiments of the present invention provide for shortened time in producing polymeric blocks via injection molding or compression molding. Whereas prior art methods of creating polymeric blocks by injecting layer after layer of plastics may take 45 to 60 minutes, in various embodiments, the present inventive method provides a way of forming all or most of the layers with just one or two injection shots and in just a fraction of the time (e.g., within 5 minutes). Further, by reducing the number of shots, the resulting block may have superior physical characteristics over blocks formed by the prior art methods, such as increased strength or decreased warping. Also, various embodiments of the present invention provide methods of forming the polymeric blocks on single shot injection machines instead of more expensive two-component injection machines.

In some embodiments, a circular shape of the connecting struts of the modular mesh part can enhance the 3D flow of molten plastic during molding. In various embodiments, the modular mesh part can be used to form an injection-molded or compression-molded block having a uniform structure with mechanical properties that are substantially uniform throughout, rather than a layered structure having mechanical properties that suffer at layer interfaces. In various embodiments, the modular mesh part can be used to form an injection-molded or compression-molded block including dissimilar materials (e.g., the modular mesh part and the molten material that is solidified around the part can have the same or different composition). In various embodiments, the modular mesh part can enable efficient mass production of various injection- or compression-molded articles or parts machined therefrom.

### BRIEF DESCRIPTION OF THE FIGURES

The drawings illustrate generally, by way of example, but not by way of limitation, various embodiments of the present invention.

FIG. 1A illustrates a front view of a modular mesh part, in accordance with various embodiments.

FIG. 1B illustrates a side view of the modular mesh part shown in FIG. 1A, in accordance with various embodiments.

FIG. 2A illustrates a front view of a stack of two layers of modular mesh parts, with each layer including four modular mesh parts, in accordance with various embodiments.

FIG. 2B illustrates a side view of the stack of two layers of modular mesh parts shown in FIG. 2A, in accordance with various embodiments.

FIGS. 3A-B illustrate a side cutaway view of an interlocking feature on a corner junction of a modular mesh part in a locked (3A) and unlocked (3B) configuration, in accordance with various embodiments.

FIG. 4A illustrates a top view of a stack of two layers of modular mesh parts in a mold cavity, each layer including four modular mesh parts, in accordance with various embodiments.

FIG. 4B illustrates a side view along line A-A of the stack of modular mesh parts shown in FIG. 4A, in accordance with various embodiments.

FIG. 4C illustrates a side view along line B-B of the stack of modular mesh parts shown in FIG. 4A, in accordance with various embodiments.

FIGS. 5A-E illustrate various configurations of an adjustable mold cavity having various numbers of modular mesh parts therein, in accordance with various embodiments.

FIG. 6 illustrates portions of an injection molding system and a first part made from a solidified first shot of molten polymeric feed material, in accordance with various embodiments.

FIG. 7 illustrates a side view of a sprue, a runner, and a plurality of gates, in accordance with various embodiments.

FIGS. 8A-8E illustrate one example of a method of the invention, in accordance with various embodiments.

FIG. 8F illustrates a perspective view of a first part, in accordance with various embodiments.

FIG. 8G illustrates a perspective view of a finished molded article, in accordance with various embodiments.

FIGS. 9A-9J illustrate perspective views of differently shaped first parts and finished articles, in accordance with various embodiments.

FIG. 10A illustrates a front view of a modular mesh part, in accordance with various embodiments.

FIG. 10B illustrates a side view of the modular mesh part shown in FIG. 10A, in accordance with various embodiments.

FIG. 10C illustrates a side cut-away view of the modular mesh part shown in FIGS. 10A-B, in accordance with various embodiments.

FIG. 11A illustrates two modular mesh parts along with three layers that together demonstrate a filled mold cavity, in accordance with various embodiments.

FIG. 11B illustrates an assembled block including two modular mesh parts, in accordance with various embodiments.

FIG. 12 illustrates a modular mesh part, having dimensions of 100 mm×100 mm×2.5 mm, in accordance with various embodiments.

FIG. 13 illustrates a plaque compression tool for overmolding a modular mesh part, with the top half on the left and the bottom half on the right, in accordance with various embodiments.

FIG. 14 illustrates a polypropylene-overmolded modular mesh part, in accordance with various embodiments.

FIGS. 15A-B illustrate an apparatus and mold including a solidified first shot, with FIG. 15B showing a close-up of FIG. 15A, in accordance with various embodiments.

FIGS. 16A-D illustrate an overlap gate system and teeth shape core design to realize block molding on a normal one injection unit machine, in accordance with various embodiments.

FIG. 16A illustrates a mold ready condition, in accordance with various embodiments.

FIG. 16B illustrates a first shot injection, in accordance with various embodiments.

FIG. 16C illustrates mold core retraction, in accordance with various embodiments.

FIG. 16D illustrates second shot injection, in accordance with various embodiments.

FIG. 17A illustrates a runner and overlap gate, in accordance with various embodiments.

FIG. 17B illustrates a first half block, in accordance with various embodiments.

FIG. 17C illustrates a total block, in accordance with various embodiments.

FIG. 18 illustrates a block with three labeled axes, in accordance with various embodiments.

FIG. 19 illustrates the shape of test bars cut from the multi-layered block, in accordance with various embodiments.

FIG. 20A illustrates the position of test bars in a multi-layered block, in accordance with various embodiments.

FIG. 20B illustrates test bars cut from the multi-layered block, in accordance with various embodiments.

FIG. 21 illustrates a test apparatus including a test bar, in accordance with various embodiments.

FIG. 22A illustrates tensile strength of various test bars, in accordance with various embodiments.

FIG. 22B illustrates elongation of various test bars, in accordance with various embodiments.

FIG. 23A illustrates a test bar that broke at the layer connect area during testing, in accordance with various embodiments.

FIG. 23B illustrates a test bar that broke outside the layer connect area during testing, in accordance with various embodiments.

FIGS. 24A-B illustrate tensile strength of various multi-layered blocks, according to various embodiments.

FIG. 25 illustrates a prototype part formed by machining a block, in accordance with various embodiments.

### DETAILED DESCRIPTION OF THE INVENTION

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “cure” as used herein refers to exposing to radiation in any form, heating, or allowing to undergo a physical or chemical reaction that results in hardening or an increase in viscosity. A flowable thermoplastic material can be cured by cooling it such that the material hardens. A flowable thermoset material can be cured by heating or otherwise exposing to irradiation such that the material hardens.

As used herein, the term “polymer” refers to a molecule having at least one repeating unit and can include copolymers.

As used herein, the term “injection molding” refers to a process for producing a molded part or form by injecting a composition including one or more polymers that are thermoplastic, thermosetting, or a combination thereof, into a mold cavity, where the composition cools and hardens to the configuration of the cavity. Injection molding can include the use of heating via sources such as steam, induction, cartridge heater, or laser treatment to heat the mold prior to injection, and the use of cooling sources such as water to cool the mold after injection, allowing faster mold cycling and higher quality molded parts or forms.

As used herein, the term “compression molding” refers to a method of molding in which the molding material, generally preheated (e.g., at least partially molten), is placed in an open, heated mold cavity. The mold is closed with a top force or plug member and pressure is applied to force the material throughout areas of the mold, while heat and pressure are maintained, to provide a cured molding material. The molding material can be any suitable molding material, such as thermosetting resins in a partially cured stage, either in the form of granules, putty-like masses, or preforms.

### Method of Injection Molding or Compression Molding an Article Including a Modular Mesh Part.

In various embodiments, the present invention provides a method of injection molding or compression molding an article. The method can include directing a shot of molten material into a mold cavity including a plurality of substantially identical modular mesh parts. The shot of molten material and the plurality of modular mesh parts in the mold cavity fill the mold cavity (e.g., such that the mold cavity is about 100% full). The method can include solidifying the shot of molten material to form the article including the plurality of modular mesh parts and the solidified shot of molten material.

The molten material directed into the mold cavity can be any suitable molten material that is predominantly a polymeric material, such as a thermoplastic polymer, a thermosetting polymer, an elastomer, or a combination thereof. For example, the polymeric material can be about 80 wt % to about 100 wt %, about 90 wt % to about 100 wt %, or about 95 wt % or more of the molten material. The modular mesh part and the molten material can have the same or different compositions. The temperature of the shot of molten material can be sufficient to at least partially melt the modular mesh parts in the mold cavity prior to the solidifying of the shot of molten material.

The polymeric material can include an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA, such as nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a poly(cyclohexylenedimethylene terephthalate-co-ethylene glycol) (PCTG), a Tritan™ copolyester, a polycarbonate polymer (PC), poly(1,4-cyclohexylidene cyclohexane-1,4-dicarboxylate) (PCCD), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), a styrene-acrylonitrile polymer (SAN), or a combination thereof.

The molten material can include one or more fillers, such as glass fillers (e.g., glass beads, glass flakes, or glass fibers), carbon fibers, fibrous fillers, particulate fillers, natural fillers, mineral fillers, or a combination thereof. The fillers can form any suitable proportion of the molten material, such as about 0.001 wt % to about 60 wt %, about 1 wt % to about 50 wt %, or about 1 wt % or less, or less than, equal to, or greater than about 10 wt %, 20, 30, 40, 50, or about 60 wt % or more. In various embodiments, high tensile strength between layers of the completed article can be approximately retained or exceeded when using filler in the molten material, such as glass fiber fillers, carbon fiber fillers, or mineral fillers.

The completed article can have any suitable shape. The article can be a block, such as having a quadrilateral shape, a circular shape, a triangular shape, a hexagonal shape, a star shape, or an irregular polygonal shape.

The modular mesh part can have any suitable shape and dimensions. The modular mesh part can have a planar profile with a perimeter having any suitable shape, such as a polygon, a circle, a hexagon, a triangle, and the like. The modular mesh part can have a rectangular-shaped perimeter (e.g., square-shaped). The modular mesh can include two major faces. The two major faces can be substantially opposing major faces, such as substantially parallel opposing major faces. The two major faces can be curved, flat, or any combination thereof. The grid can include through-holes. The through-holes can run orthogonal to the two major faces, or at an angle other than 90 degrees with respect to the two major faces. The through-holes can occupy any suitable surface area of the two major faces, such as about 10% to about 90% of a surface area of each of the major faces (e.g., of the top face, or of the bottom face), or about 10% or less, or less than, equal to, or greater than about 20%, 30, 40, 50, 60, 70, 80, or about 90% or more.

The thickness of the modular mesh part (e.g., the thickness of the plane occupied by the modular mesh part) can be about 0.1% to about 10% of a length of either edge of the modular mesh part, such as about 1% to about 2% of a length of either edge of the modular mesh part, or about 0.1% or less, or less than, equal to, or greater than about 0.2%, 0.4, 0.6, 0.8, 1, 1.5, 2, 2.5, 3, 4, 5, 6, 8, or about 10% or more. The modular mesh can have a thickness of about 0.1 mm to about 10 mm, or about 1 mm to about 5 mm, or about 0.1 mm or less, or less than, equal to, or greater than about 0.2 mm, 0.3, 0.4, 0.5, 0.6, 0.8, 1, 1.2, 1.4, 1.6, 1.8, 2, 2.2, 2.4, 2.6, 2.8, 3, 3.2, 3.4, 3.6, 3.8, 4, 4.5, 5, 6, 7, 8, 9, or about 10 mm or more. The modular mesh can have an edge length of about 10 mm to about 1 m, or about 50 mm to about 500 mm, or about 10 mm or less, or less than, equal to, or greater than about 20 mm, 30, 40, 50, 60, 70, 80, 90, 100, 110, 120, 130, 140, 150, 160, 170, 180, 190, 200, 220, 240, 260, 280, 300, 350, 400, 450, 500, 600, 700, 800, 900 mm, or about 1 m or more. For example, the modular mesh can have a thickness of about 2.5 mm with a perimeter of about 100 mm×100 mm, or about 150 mm×150 mm, or about 300 mm×300 mm.

The modular mesh part includes a grid including a first set of parallel struts and a second set of parallel struts. The first and second sets of struts can be perpendicular to one another and can intersect throughout the modular mesh part at junctions. The first and second sets of struts can have an approximately uniform shape with a largest cross-sectional dimension that is approximately the same throughout the modular mesh part. The junctions can have an approximately uniform shape with a largest cross-sectional dimension that is approximately the same throughout the modular mesh part. The junctions can have a largest cross-sectional dimension that is about 50% to about 150% of a largest cross-sectional dimension of the struts, or about 50% or less, or less than, equal to, or greater than about 60%, 70, 80, 90, 100, 110, 120, 130, 140, or about 150% or more. The junctions can have a largest cross-sectional dimension that is about the same as a largest cross-sectional dimension of the struts.

The plurality of the modular mesh parts can form a layer including one or more than one modular mesh part per layer, a stack including more than one layer of modular mesh parts, or a combination thereof. Modular mesh parts forming a layer can interlock within the layer, and modular mesh parts forming a stack can interlock between layers, such as via interlocking features that interlock with corresponding interlocking features on one or more adjacent modular mesh parts (e.g., adjacent within the same layer, adjacent within a neighboring layer, or a combination thereof). The interlocking features can be located near the periphery of the modular mesh part—e.g. on the edges or on the top or bottom surfaces near the edges (such as adjacent the edges). Junctions at the corners of the modular mesh part can include the interlocking features. The interlocking features can be considered as attached to the corner junctions, such that the corner junctions can be considered to have a uniform shape with the rest of the junctions in the modular mesh part. The interlocking features on adjacent interlocking modular mesh parts that meet and interlock with one another can be the same or different. The interlocking features can include a peg (e.g., pin, cylinder) on one part that interlocks with a hole or pocket in the other part. In some examples, the peg and hole can fit together with no deformation. In another example, the peg, hole, both can have a slot cut therein perpendicular to the longitudinal direction, such that the peg can slightly compress in diameter or the hole can slightly widen in diameter, allowing the slightly deformed interlocked parts to have enhanced friction therebetween and resist being taken apart. Interlocking parts having deformability can advantageously allow for more secure interlocking in the presence of slight variations in the size or shape of the modular mesh part or the interlocking feature.

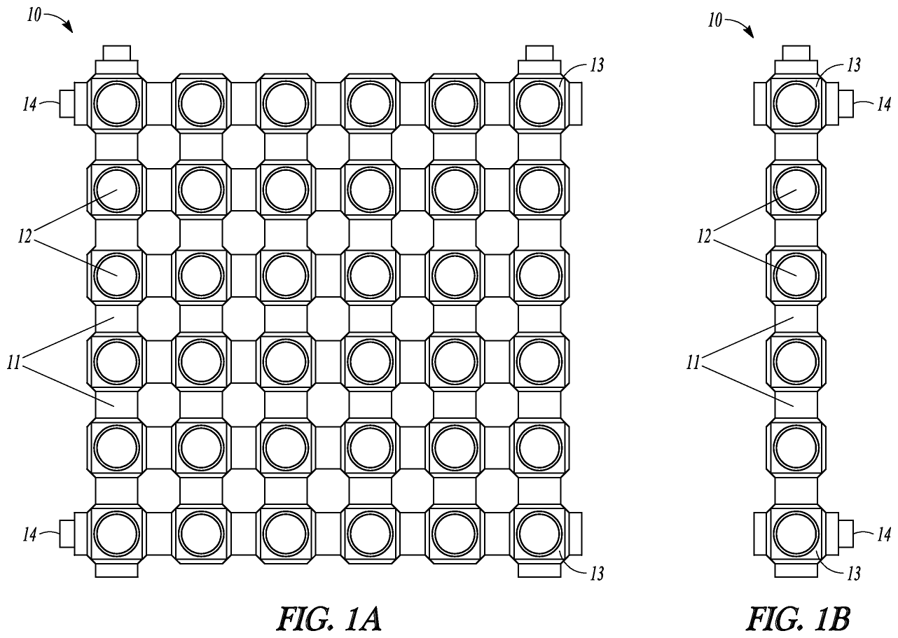

FIG. 1A illustrates a front view of a modular mesh part 10. The modular mesh part 10 includes connecting struts 11, which intersect at junctions 12. Corner junctions 13 include interlocking features 14. The corner junctions 13 can provide a reinforcing effect on the molded article. The corner junctions 13 can comprise a spheroid shape. FIG. 1B illustrates side view of the modular mesh part 10 shown in FIG. 1A.

The plurality of modular mesh parts can form a layer in the mold cavity, such as via edge-to-edge contacting or connection with adjacent modular mesh parts in the layer. The edge-to-edge contacting or connection can be discontinuous, such that the shot of molten material can easily flow between adjacent modular mesh parts in the layer. The discontinuous contacting or connection can include contact between the corners of the adjacent modular mesh parts, wherein adjacent modular mesh parts in the layer are otherwise free of contact with one another. The contacting corners of adjacent modular mesh parts can include interlocking features. For example, one corner of a part can have a peg, and the contacting corner of the adjacent modular mesh part can have a hole that fits the peg.

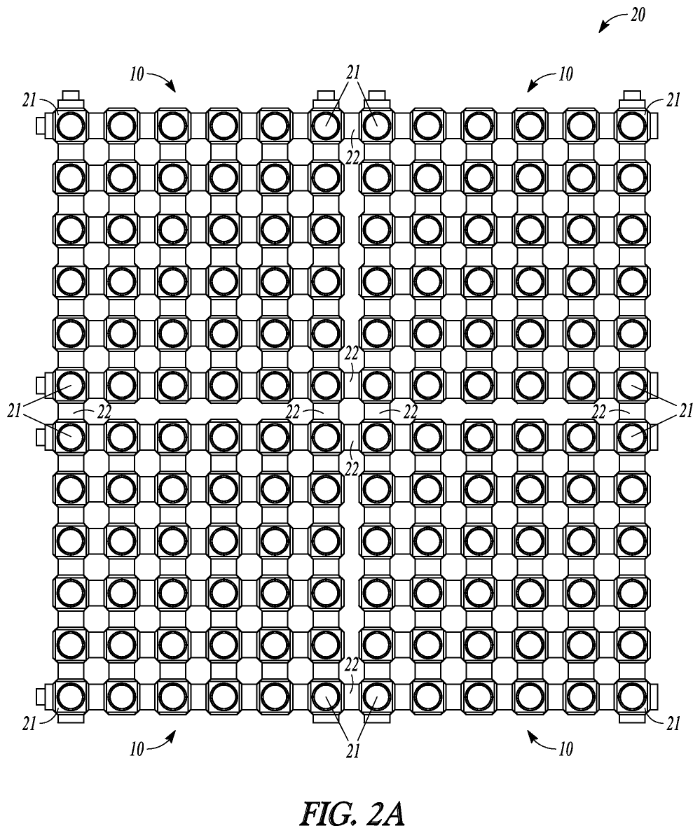

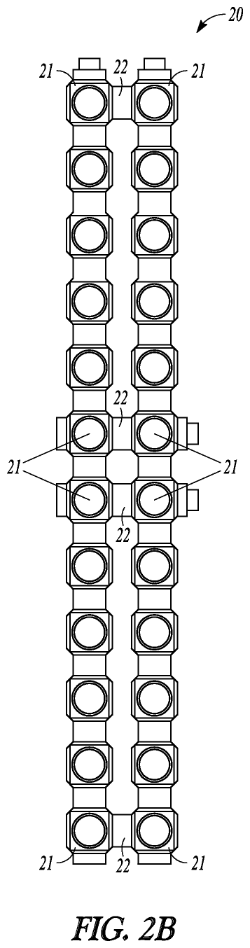

FIG. 2A illustrates a top view of a stack of two layers 20 each including four of the modular mesh parts 10 shown in FIGS. 1A-B. The other layers of the stack cannot be seen because they are hidden behind the visible layer (e.g., the edges of the modular mesh parts of the layer 20 align with edges of adjacent plastic mesh parts in adjacent layers). The layer 20 includes corner junctions 21. The corner junctions 21 form intra-layer connections 22 between the four squares 10. The edge-to-edge contacting between the four squares 10 is discontinuous, and is free of contact other than the connections 22. The connections 22 can be interlocking features.

The plurality of modular mesh parts can form a stack of layers, wherein each layer can include one or more of the modular mesh parts. The modular mesh parts of a layer of the stack can form a discontinuous face-to-face connection with adjacent modular mesh parts of adjacent layers of the stack, to allow the molten material to flow freely between the layers. The edges of the modular mesh parts of a layer of the stack can align with edges of adjacent modular mesh parts of adjacent layers of the stack. The discontinuous face-to-face connection between the adjacent modular mesh parts in the adjacent layer can include contact between the corners of the adjacent modular mesh parts. The adjacent modular mesh parts in the adjacent layers can be otherwise free of contact with one another. The contacting corners of adjacent modular mesh parts in the adjacent layers include interlocking features.

FIG. 2B illustrates a side view of the stack of two layers 20 shown in FIG. 2A. Each layer 20 includes corner junctions 21. The corner junctions 21 form inter-layer (e.g., face-to-face) contacting 22 between the layers 20. The face-to-face contacting 22 between the layers 20 is discontinuous, and is free of contact other than the connections 22. The connections 22 can be interlocking features.

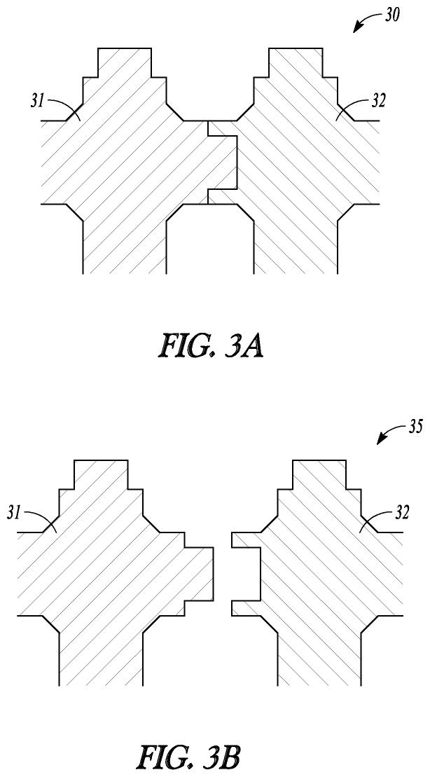

FIGS. 3A-B illustrate a side cutaway close-up view of locking features. FIG. 3A illustrates a locked configuration 30 between junctions 31 and 32 (which connect to connecting struts, not shown). FIG. 3B illustrates an unlocked configuration 35 between junctions 31 and 32. FIGS. 3A-B illustrate only one embodiment of interlocking features; any suitable interlocking feature can be used.

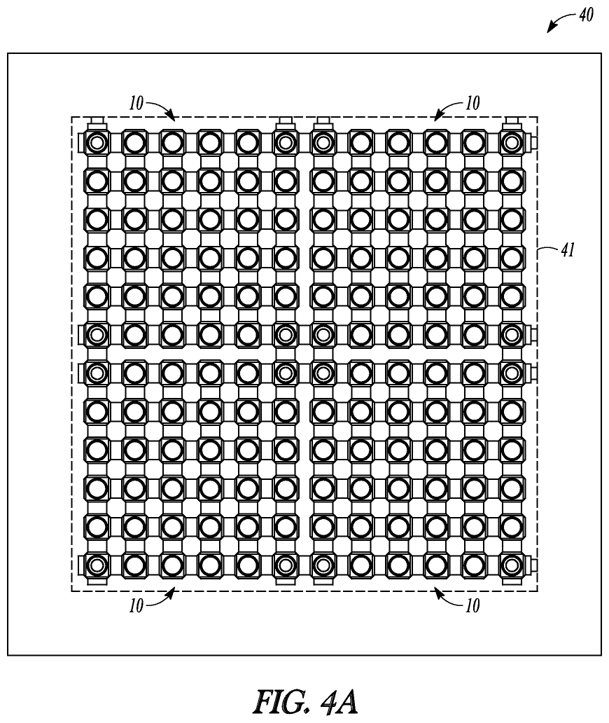

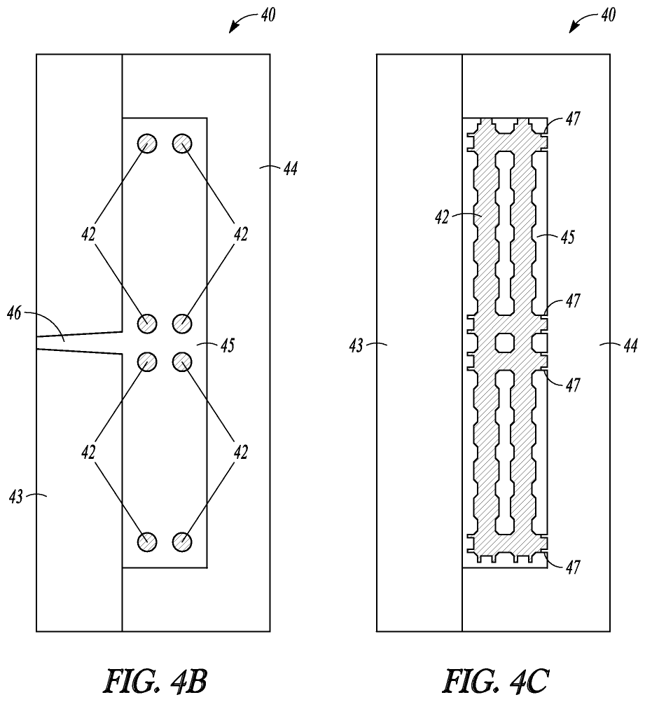

FIG. 4A illustrates a top view of an overmolded stack of two layers 40, each layer including four modular mesh parts 10. The overmolded stack is in a mold cavity 41. FIG. 4B illustrates a side view of the overmolded stack of two layers 40 shown in FIG. 4A. Only a small section of the modular mesh parts 10 is visible 42. The mold cavity 41 includes first half 43 and second half 44. The mold cavity includes overmolding 45, which entered the mold via sprue 46. FIG. 4C illustrates a side view of the overmolded stack of two layers 40 shown in FIG. 4A. Only a small section of the modular mesh parts 10 is visible 42, surrounded by overmolding 45. The second half 44 of the mold cavity includes guide holes 47 that fit or interlock with adjacent modular mesh parts. The mold can include guide holes or slots on the sides, front, or back. The guide holes or slots can align with any suitable portion of the modular mesh parts, such as with protruding features designed to interlock with corresponding features on other modular mesh parts, such as with pegs or pins on the parts. In some embodiments, the interlocking parts can protrude beyond the plane of the modular mesh part such that it protrudes from the exterior of the overmolded layer or stacked layers, allowing overmolded parts to be easily held in place within molds while being made, and allowing the final overmolded parts to be easily and securely interlocked to one another to create even thicker parts.

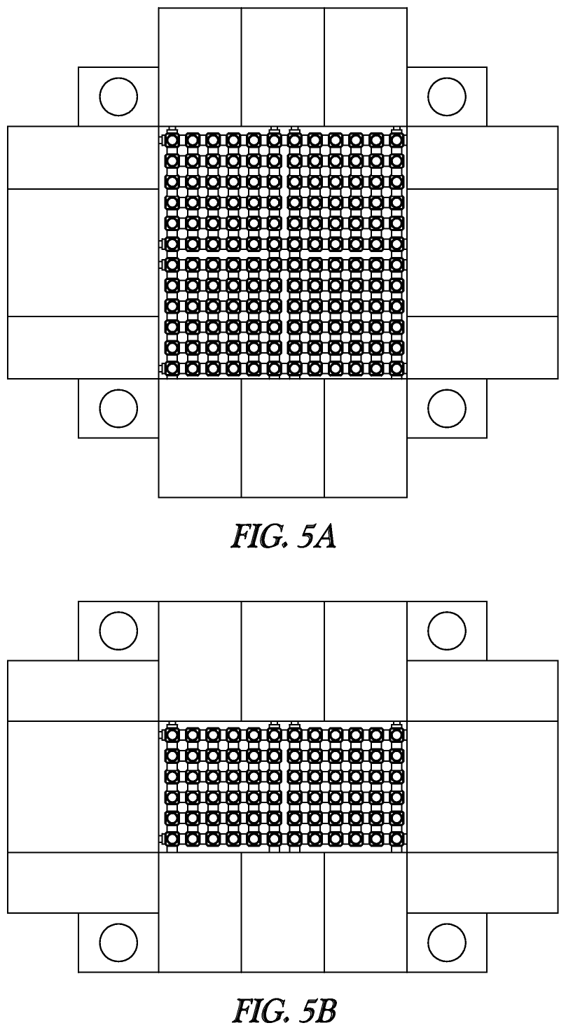

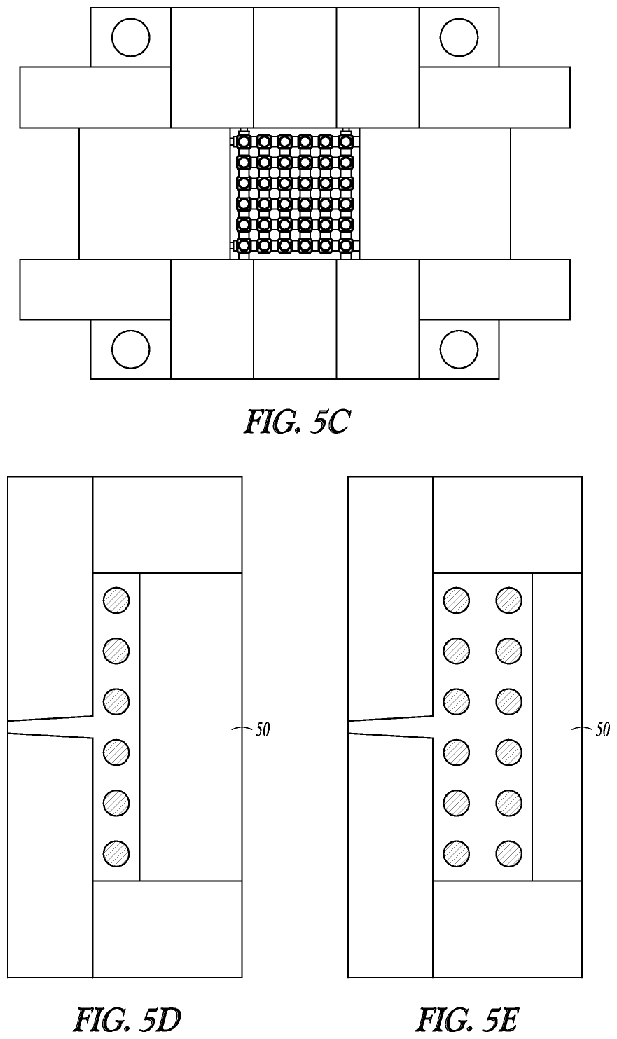

The size of the mold cavity can be adjustable to accommodate different sizes (e.g., different numbers of modular mesh parts in each layer, and different numbers of layers, such as modification in the X-direction, Y-direction, Z-direction, or a combination thereof). The number of modular mesh parts used in a layer or stack can be varied to adjust for size and shape of the article to be molded while interlocking between adjacent modulus mesh enables consistent structural arrangement throughout the article as the adjacent modulus mesh will be constrained from moving relative to each other during injection of the molten material. For example, as illustrated in FIGS. 5A-C, the mold cavity can be adjusted to accommodate a layer including four square-shaped (e.g., 150 mm×150 mm) modular mesh parts (FIG. 5A), a layer including two of such modular mesh parts (FIG. 5B), or a layer including a single one of such modular mesh parts (FIG. 5C). The thickness of the mold cavity can be sufficient to accommodate any suitable number of layers of the modular mesh parts (e.g., about 2 to about 1,000, or about 2 to about 100, or about 2 to about 50). As illustrated in FIGS. 5D-E, the mold cavity can be adjusted via changeable core insert 50 to accommodate 1 layer (FIG. 5D) or two layers (FIG. 5E) of the modular mesh parts. Core inserts can be any suitable shape. Core inserts can include one or more guide holes or slots for interlocking or aligning with corresponding features on the modular mesh part such as pegs or pins. In some examples, a core insert can be square-or rectangular-shaped and can have a square- or rectangular-shaped open area in the middle where the modular mesh parts fit for the overmolding process, with the area in the middle of the core insert optionally including guide holes or slots for aligning with pegs on the modular mesh part during the overmolding process. In some examples, the core insert can allow production of overmolded parts having a thickness of 25-100 mm, such as 25 mm or 50 mm.

In some embodiments, the method includes forming the modular mesh part, such as via injection molding or compression molding or additive layer manufacturing.

The method can further include machining the article (e.g., milling or otherwise cutting away sections of) to form a part, such as using a CNC machine. The part can be a prototype part, and the method can be a method of prototyping (e.g., a method of forming a prototype part).

### Modular Mesh Part.

In various embodiments, the present invention provides a modular mesh part for injection molding or compression molding an article. The modular mesh part can be any suitable modular mesh part that can be used to carry out an embodiment of the method described herein for injection molding or compression molding an article including a modular mesh part. For example, the modular mesh part can include a thermoplastic polymer, a thermosetting polymer, an elastomer, an injection-molded part, a compression-molded part, a blow-molded part, a thermoformed part, a part made by additive layer manufacturing, a metal, graphite, graphene, a composite, a circuit, or a combination thereof. The modular mesh part can be a modular plastic mesh part (e.g., that is 50 wt % or more plastic, or 90 wt % or more plastic, or 100 wt % plastic). The modular plastic mesh part can consist of one or more polymers or elastomers and optional fillers or additives blended with the plastic. The modular mesh part may be a solid body (i.e. not hollow or porous). The modular plastic mesh part can be free of fibers. The modular plastic mesh part can comprise at least one of a thermoplastic polymer, a thermosetting polymer, an elastomer, and preferably, can be free of fibers. The modular mesh part can have a shape including a square-shaped planar grid including two substantially parallel opposing major faces. The shape can include through-holes running orthogonal to the two major faces. The shape can include a first set of parallel struts and a second set of parallel struts. The first and second sets of struts can be perpendicular to one another and intersect throughout the modular mesh part at junctions. The first and second sets of struts can have an approximately uniform shape with a largest cross-sectional dimension that is approximately the same throughout the modular mesh part. The junctions can have an approximately uniform shape with a largest cross-sectional dimension that is approximately the same throughout the modular mesh part. The junctions can have a largest cross-sectional dimension that is about 50% to about 150% of a largest cross-sectional dimension of the struts. The junctions at the corners of the modular mesh part can further including interlocking features that are sufficient to interlock with corresponding interlocking features on one or more adjacent ones of the modular mesh part in a layer or stack of the modular mesh parts.

### Injection-Molded or Compression-Molded Article.

In various embodiments, the present invention provides an article (e.g., block) formed by an embodiment of the method described herein for injection molding or compression molding an article including a modular mesh part (e.g., a modular plastic mesh part). For example, the injection-molded or compression-molded block can include an embodiment of the modular mesh part described herein (e.g., one more of such modular mesh parts), and a solidified material encasing the modular mesh part and having the same or different composition as the modular mesh part.

Machined Part Formed from Article Including Modular Mesh Part.

Various embodiments of the present invention provide a part machined from an article (e.g., block) of the present invention, such as a part machined from a block formed using an embodiment of the method described herein for injection molding or compression molding an article including a modular mesh part.

### Method of Forming a Part.

Various embodiments of the present invention provide a method of forming a part. The method can include forming a block including at least one shot of molten material solidified in contact with another solidified material using an injection molding or compression molding technique. The method can include machining the block to form the part. The method of forming the block can be any suitable method described herein, such as using an embodiment of the method described herein for injection molding or compression molding an article including a modular mesh part, or via a different technique described in this section.

The molten material directed into the mold cavity can be any suitable molten material that is predominantly a polymeric material, such as a thermoplastic polymer, a thermosetting polymer, an elastomer, or a combination thereof. For example, the polymeric material can be about 80 wt % to about 100 wt %, about 90 wt % to about 100 wt %, or about 95 wt % or more of the molten material. The solidified material and the molten material can have the same or different compositions. The temperature of the shot of molten material can be sufficient to at least partially melt the solidified material in the mold cavity prior to the solidifying of the shot of molten material.

Forming the block can include extruding rods of molten material, allowing the rods to solidify, and cutting the rods. The method can include assembling the solid rods on a plate. The method can include mounting the rods on the plate in a mold cavity. The method can include overmolding molten material around the rods and allowing the molten material to solidify to form the block.

In some embodiments, the block can include multiple solidified layers. The multiple solidified layers can be a stack having a thickness of 60 mm or more, or a stack including about 2 to about 1,000 layers, or about 2 to about 100, or about 2 to about 50 layers, each layer having a thickness of about 0.1 mm to about 10 mm, or about 1 mm to about 5 mm, or about 0.1 mm or less, or less than, equal to, or greater than about 0.2 mm, 0.3, 0.4, 0.5, 0.6, 0.8, 1, 1.2, 1.4, 1.6, 1.8, 2, 2.2, 2.4, 2.6, 2.8, 3, 3.2, 3.4, 3.6, 3.8, 4, 4.5, 5, 6, 7, 8, 9, or about 10 mm or more.

Forming the block can include directing a shot of molten material into a mold cavity. The method can include solidifying the shot of molten material to form a first layer. The method can include enlarging the size of the mold cavity. The method can include directing a second shot of molten material into the mold cavity. The method can include solidifying the second shot of molten material to form a second layer stacked on the first layer. The method can also include optionally repeating the method to form a stack having more than two layers.

Enlarging the size of the mold cavity can include removing spacer pads to allow a movable core that is at least one side of the mold cavity to move. Enlarging the size of the mold cavity can include moving a wedge to allow a movable core that is at least one side of the mold cavity to move. The wedge can include steps that correspond with and mate to steps on the movable core. The wedge can include a smooth surface that corresponds with and mates with a smooth surface on the movable core. Enlarging the size of the mold cavity can occur as the second shot of molten material is directed into the mold cavity.

In some embodiments, forming the block includes directing a shot of molten material into a mold cavity including a plurality of contacting substantially identical modular mesh parts to fill the mold cavity. The method can include solidifying the shot of molten material to form the article including the plurality of modular mesh parts and the solidified shot of molten material.

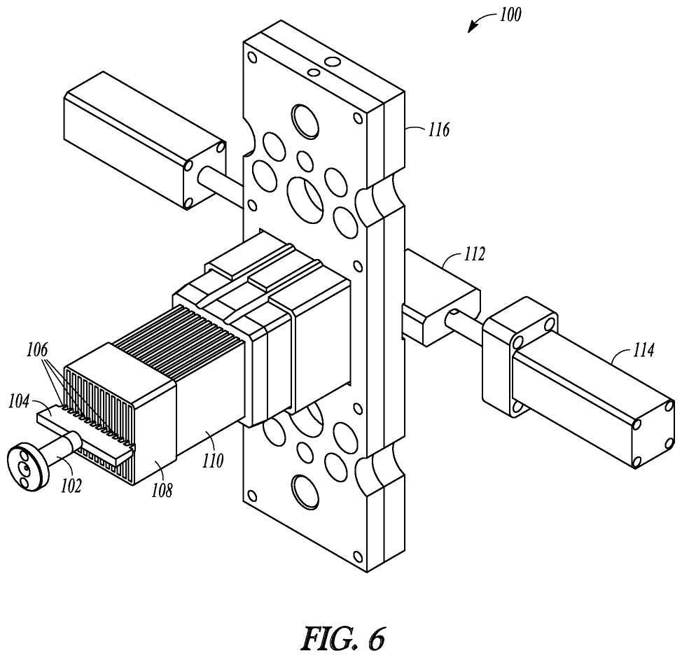

FIG. 6 illustrates one example of the present invention in the form of portions of an injection molding system 100. System 100 includes a sprue bushing 102, a runner 104, a plurality of gates 106, a mold core 110, a lock 112, a hydraulic cylinder 114, and a plate 116. FIG. 6 also illustrates a first part 108 made from a solidified first shot of molten polymeric feed material.

The sprue bushing 102 is in direct or indirect fluid communication with a melt source of molten material (not illustrated in the figure), such as a heated screw. As illustrated in system 100, the sprue bushing 102 is also in direct fluid communication with a runner 104, though the sprue bushing may be in indirect fluid communication with a runner in other examples of the invention. The runner 104 is in direct fluid communication with a series of injection gates and indirect fluid communication with the mold cavity (not fully illustrated in the figures) of the injection molding system 100. As used herein, when two components of the invention are described as being in “direct fluid communication”, it is meant that a fluid can pass from the first component to the second component without travelling through any intermediary components. When two components of the invention are described as being in “indirect fluid communication,” it is meant that the fluid can pass from the first component to the second component but must first travel through one or more intermediary components.

The plate 116 is driven by a hydraulic cylinder (not fully illustrated in the figures) which moves the plate 116 forward and backward. The plate 116 is secured to the mold core 110. The mold core 110 is movable relative to the runner 104 and the sprue bushing 102. The hydraulic cylinder 114 can be used to engage or disengage the lock 112 with the plate 116, thereby allowing the system 100 to lock the position of mold core 110 relative to the runner 104 and the sprue bushing 102.

FIG. 7 illustrates another example of the present invention in the form of a side view illustration of a sprue 218, a runner 204, and a plurality of gates 206. The sprue 218 and runner 204 are shared by the plurality of gates 206 and, in operation, are all in fluid communication with one another. In the example shown in FIG. 7, each individual gate 206 defines a gate orifice area of approximately 5.0 millimeters in length and 1.6 millimeters in width.

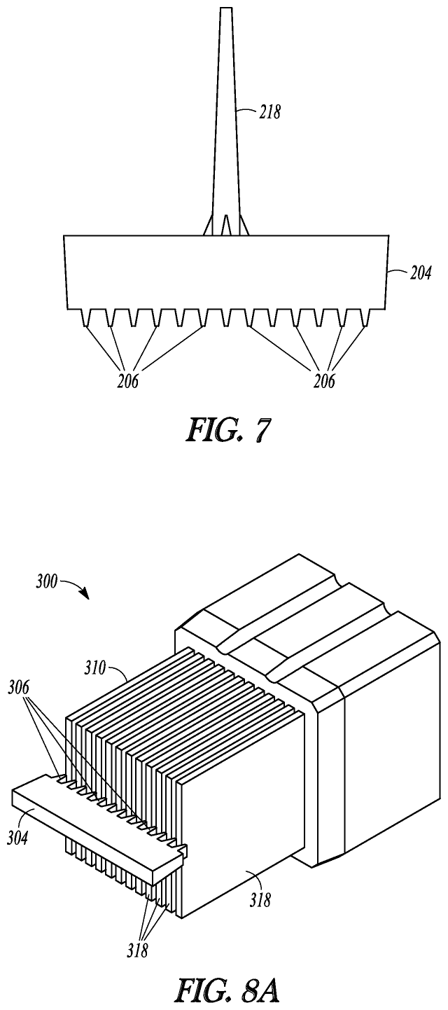

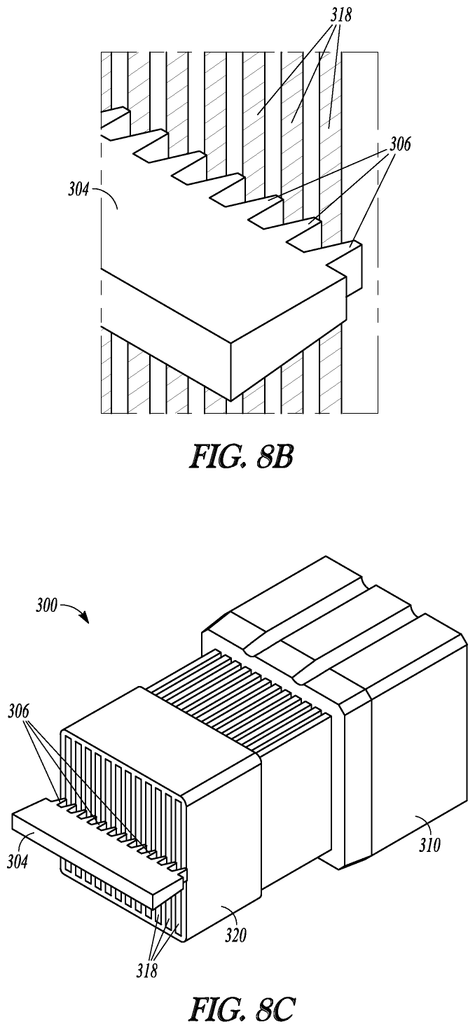

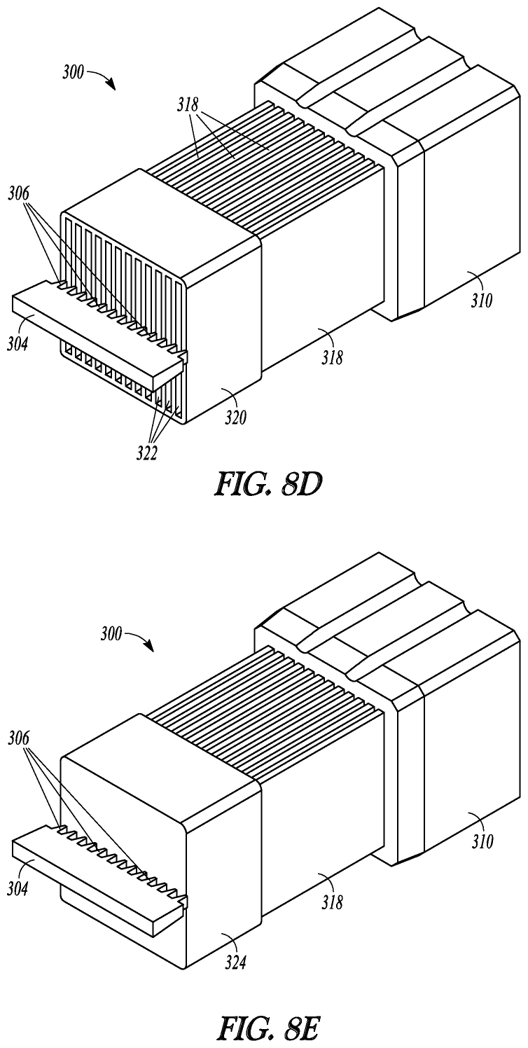

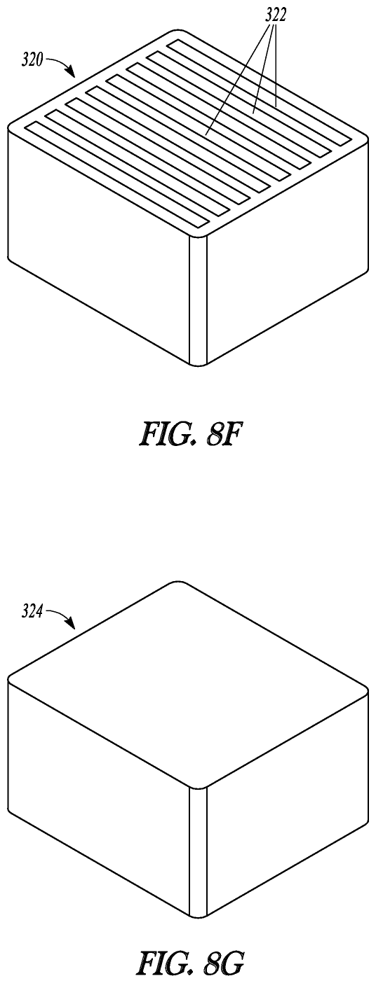

The present invention also includes methods of injection molding an block. FIGS. 8A-8F illustrate one example of a method of the invention.

FIG. 8A illustrates some of the initial steps of an exemplar method, which includes providing an injection molding machine or system 300. The injection molding system 300 used in this method includes the same components as system 100 illustrated in FIG. 6, though a number of the components have been omitted from FIGS. 8A-8E for clarity. The system 300 includes a melt source of molten material, a mold defining a mold cavity, one or more gates 306, and a mold core 310 movable relative to the one or more gates 306. A runner 304 feeds all of the gates 306 with molten material during operation. The molten material may be a thermoplastic, a thermosetting material, or an elastomer, and mold core 310 may be a reusable mold core.

The one or more gates 306 collectively define a total orifice area through which molten material will be injected into the mold cavity, and the mold core 310 is directed or positioned next to the one or more gates 306 such that the mold core 310 obstructs or occludes a first portion of that total orifice area of the one or more gates 306. The second or remaining portion of the one or more gates 306 is unobstructed by the mold core 310. FIG. 8A illustrates the gate obstruction and FIG. 8B illustrates a close up view. As shown in FIG. 8A, the mold core 310 includes a series of parallel “teeth” or prongs 318 arranged in a parallel fashion and having parallel opposing surfaces. In other examples, the mold core may obstruct the entire orifice area of a portion of the one or more gates while leaving the remaining gates unobstructed. In either example, the mold core is obstructing a portion of the total orifice area of the gates. To state it another way, the mold core obstructs a portion of the total orifice area of the gates and may do so by partially obstructing each gate or by completely obstructing a portion of the gates. For example, the system may be designed such that the mold core obstructs half of the total orifice area of the gates by obstructing half of the orifice area of each gate or obstructing all of the orifice area of half of the gates. In further examples, the mold core may obstruct anywhere from 1-99% of the total orifice area and may do so by obstructing 1-100% of the orifice area of 1-100% of the gates in the system (provided that at least some portion of the total orifice area remains unobstructed).

While the mold core 310 is obstructing a portion of the total orifice area of the one or more gates 306, a first shot of molten material is directed or injected into the mold cavity through the unobstructed portion of the total orifice area of the one or more gates 306. When the first shot of molten material enters the mold cavity, the flow boundaries of the cavity are at least partially defined by the surfaces of the mold core 310, and the first shot of molten material infiltrates and flows into the spaces that separate opposing parallel faces of the adjacent prongs 318 of the mold core 310. After injection, the first shot of molten material is solidified to form a first part 320 of the molded block, as illustrated in FIG. 8C. The mold core 310 may define channels for the flow of cooling fluid (e.g., water or other cooling media) so that the first part 320 can be quickly cooled, while in other examples the mold core 310 may not include cooling channels and may simply be a solid core.

After the first part 320 of the molded block has been formed, the mold core 310 is directed away from the one or more gates 306, as illustrated in FIG. 8D. A space for a second shot of molten material is formed when the prongs 318 of the mold core 310 are pulled back from the one or more gates 306 and the runner 304. That is, each of the prongs 318 leaves a complementary space or void 322 when the mold core 310 is pulled away from the gates 306 and, collectively, those voids 322 form a space for additional shots of molten material. Pulling the mold core 310 away from the one or more gates 306 also opens up the previously obstructed portion of the total orifice area of the one or more gates 306. That is, directing the mold core 310 away from the one or more gates 306 removes the obstruction of the gates 306 by the mold core 310.

After the mold core 310 is directed away from the one or more gates 306, a second shot of molten material is directed into the mold cavity through the portion of the total orifice area of the one or more gates 306 that was previously obstructed by the mold core 310 while the portion of the total orifice area through which the first shot of molten material was injected remains obstructed by the first part 320 of the molded block. As the second shot is injected, the molten material fills the voids 322 forming the second shot space of the mold cavity.

After the second shot is injected, the second shot of molten material is solidified to form a second part of the molded block 324, as illustrated in FIG. 8E. As shown, molded block 324 is a polymer square or rectilinear block. While the molded block 324 in FIG. 8E is shown as a square or rectilinear block, the methods of this invention can create virtually any shape that is amendable to being formed in a two-step injection process where the mold core is used to obstruct a first portion of the total gate orifice area and then pulled back to provide space for a second shot of material.

FIG. 8F illustrates a perspective view of a first part 320 formed after solidification of the first shot of molten material. As can be seen, the first part 320 includes a plurality of parallel portions formed when the molten material is injected into a mold cavity and flows between the prongs 318 of the mold core 310, thereby resulting in a plurality of voids 322. FIG. 8G illustrates a perspective view of a finished molded block 324 after it has been ejected from the system 300. As can be seen, the block 324 is a solid cube of polymer material.

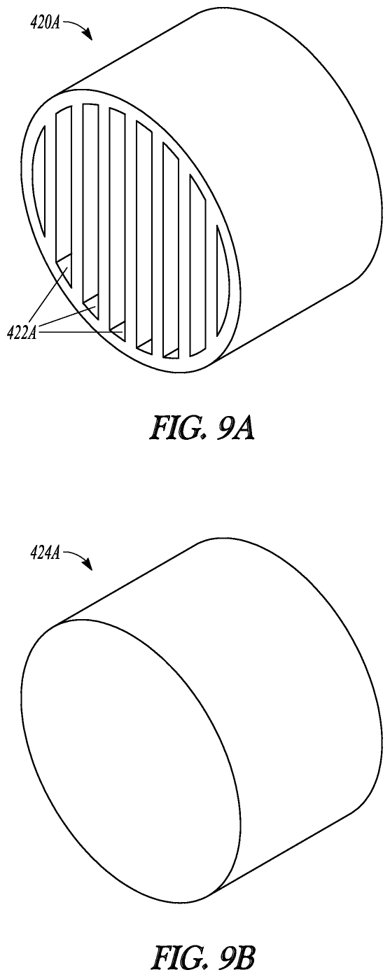

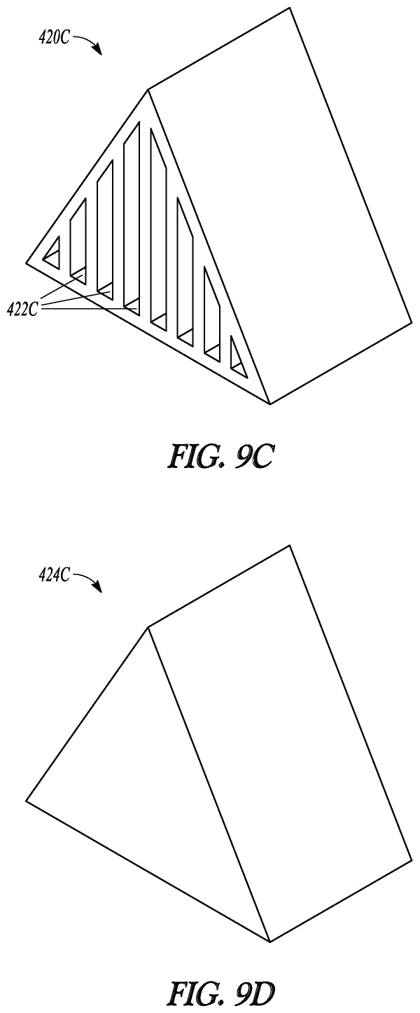

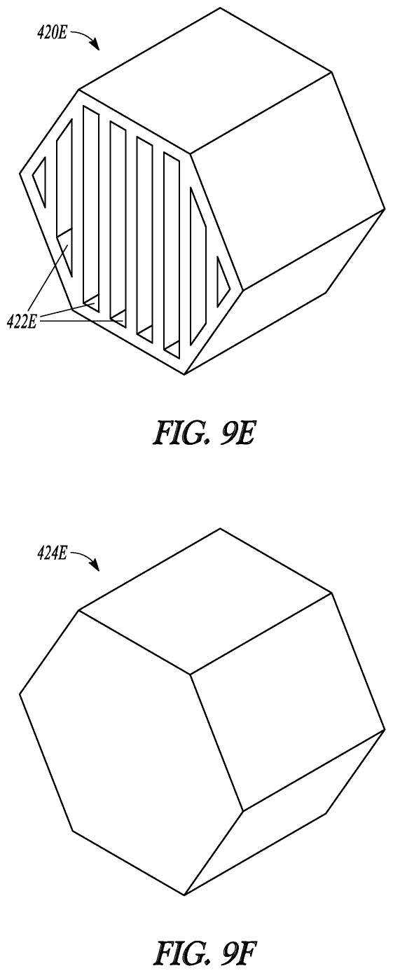

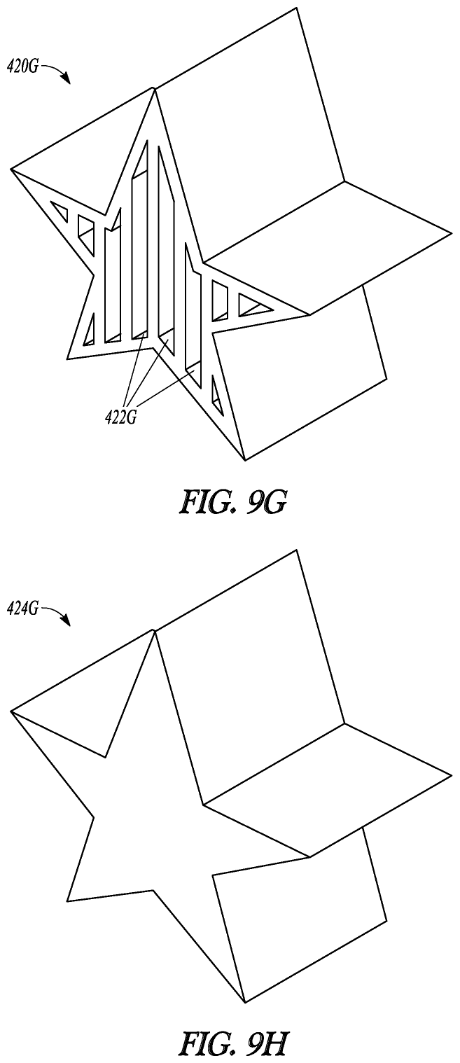

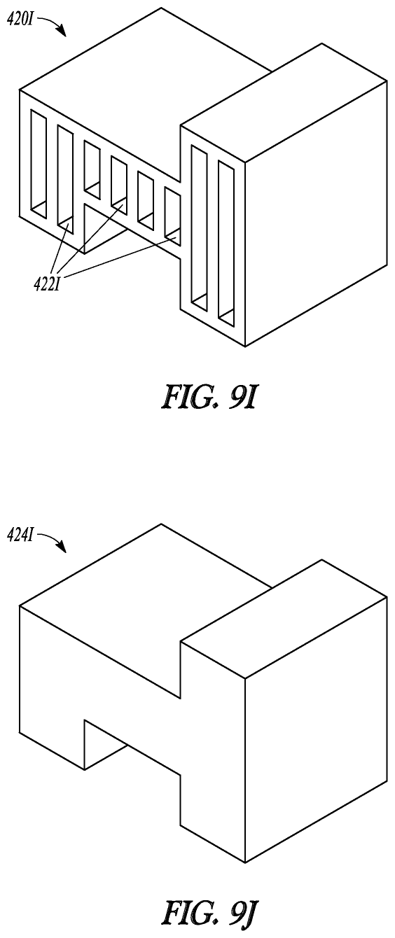

While first part 320 and block 324 are cube-shaped, the present invention can be used to produce a wide range of differently shaped parts and finished blocks. FIGS. 9A-9J show just a small variety of the different shaped blocks that can be made with the present invention.

FIG. 9A illustrates a tube-shaped first part 420A formed by the methods of the present invention. The first part 420A includes a circular cross-sectional shape. The prongs of a mold core have left a plurality of voids 422A in the first part 420A. FIG. 9B illustrates the finished block 424A formed after the voids 422A have been filled by subsequent shots of molten material (e.g., by a second shot of molten material).

FIG. 9C illustrates a tube-shaped first part 420C formed by the methods of the present invention. The first part 420C includes a triangular cross-sectional shape. The prongs of a mold core have left a plurality of voids 422C in the first part 420C. FIG. 9D illustrates the finished block 424C formed after the voids 422C have been filled by subsequent shots of molten material (e.g., by a second shot of molten material).

FIG. 9E illustrates a tube-shaped first part 420E formed by the methods of the present invention. The first part 420E includes a hexagonal cross-sectional shape. The prongs of a mold core have left a plurality of voids 422E in the first part 420E. FIG. 9F illustrates the finished block 424E formed after the voids 422E have been filled by subsequent shots of molten material (e.g., by a second shot of molten material).

FIG. 9G illustrates a tube-shaped first part 420G formed by the methods of the present invention. The first part 420G includes a star-shaped cross-section. The prongs of a mold core have left a plurality of voids 422G in the first part 420G. FIG. 9H illustrates the finished block 424G formed after the voids 422G have been filled by subsequent shots of molten material (e.g., by a second shot of molten material).

FIG. 9I illustrates a block-shaped first part 4201 formed by the methods of the present invention. The first part 4201 is shaped in the form of a tube having an irregular polygonal cross-sectional shape. The prongs of a mold core have left a plurality of voids 4221 in the first part 4201. FIG. 9J illustrates the finished block 4241 formed after the voids 4221 have been filled by subsequent shots of molten material (e.g., by a second shot of molten material).

Machined Part Formed from Article Including Modular Mesh Part.

Various embodiments of the present invention provide a part machined from a block formed using an embodiment of the method of forming a block including at least one shot of molten material solidified in contact with another solidified material using an injection molding or compression molding technique. The part can be any suitable part that can be machined from a block formed by the present invention.

### EXAMPLES

Various embodiments of the present invention can be better understood by reference to the following Examples which are offered by way of illustration. The present invention is not limited to the Examples given herein.

### Example 1. Additive Layer Manufacturing Generation of Modular Plastic Mesh Part

Additive layer manufacturing was used to form a modular plastic mesh part.

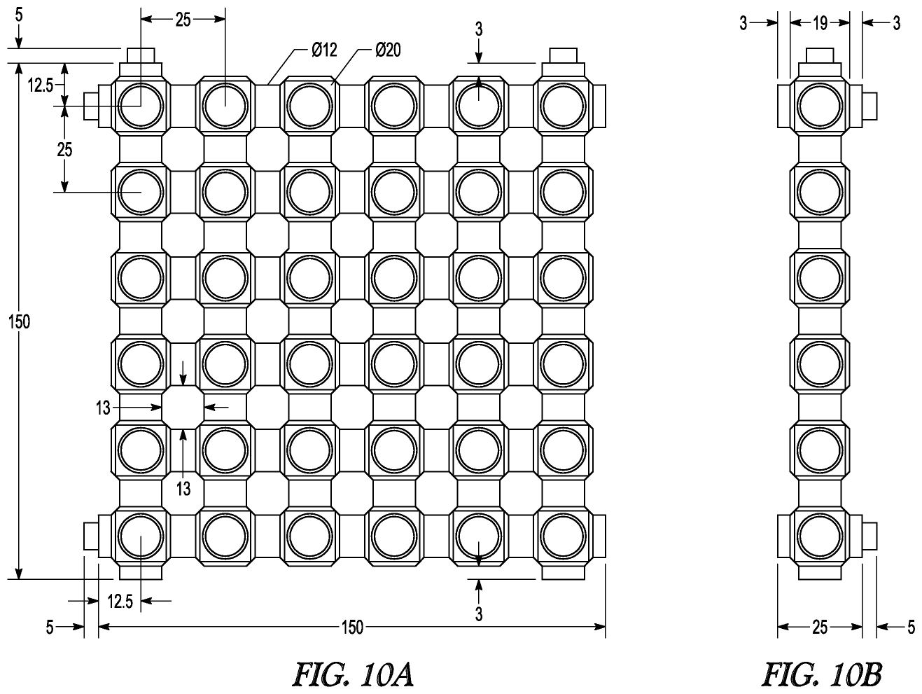

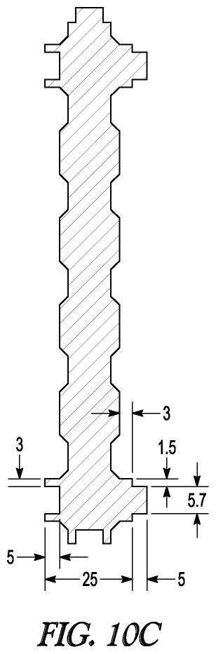

A front view of the modular plastic mesh part is shown in FIG. 10A, with the dimensions in FIGS. 10A-C given in mm. A side view of the modular plastic mesh part is shown in FIG. 10B. FIG. 10C illustrates a side cut-away view of the modular plastic mesh part.

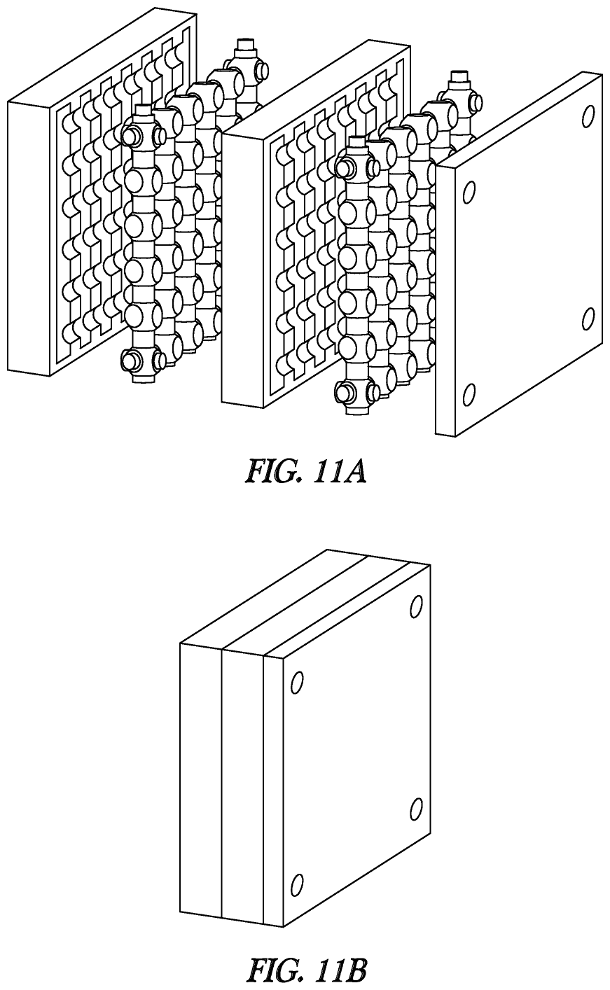

FIG. 11A illustrates two modular plastic mesh parts along with three layers, all formed via additive layer manufacturing. The two modular plastic mesh parts have the dimensions indicated in FIGS. 10A-C, and the three other layers have corresponding dimensions. Together, the two modular plastic mesh parts, along with three layers in FIG. 11A demonstrate a filled mold cavity. FIG. 11B illustrates an assembled block including the two modular plastic mesh parts of FIG. 11A.

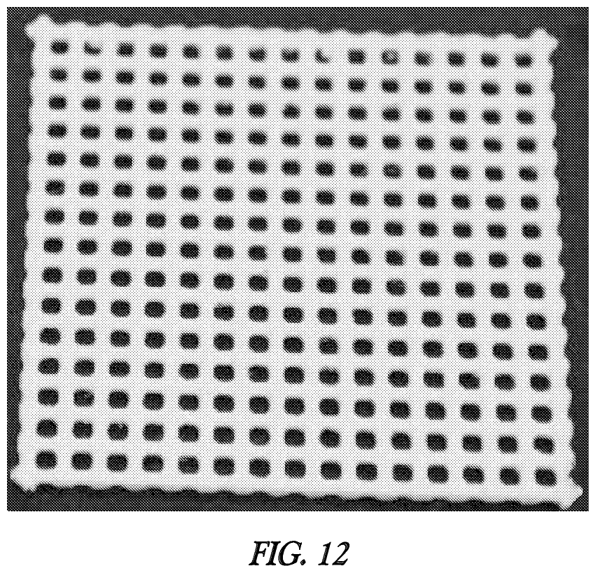

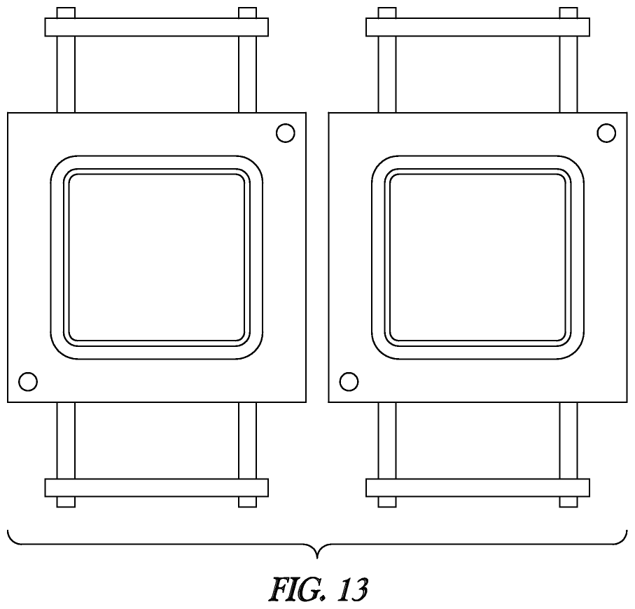

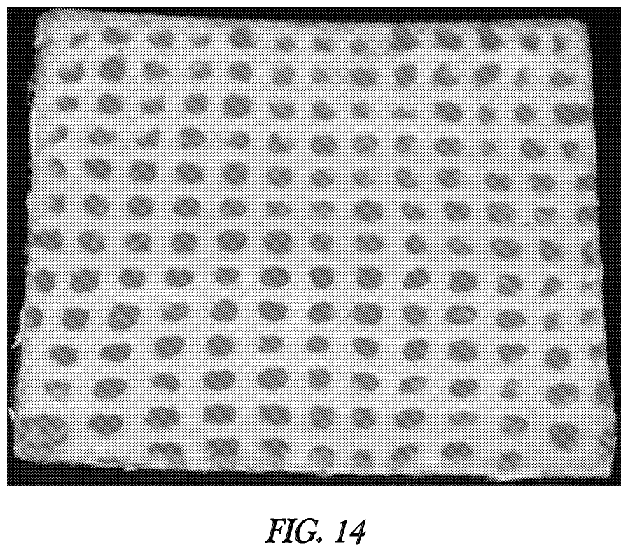

FIG. 12 illustrates a modular plastic mesh part, having dimensions of 100 mm×100 mm×2.5 mm, formed via additive layer manufacturing. FIG. 13 illustrates a plaque compression tool for overmolding a modular plastic mesh part, with the top half on the left and the bottom half on the right. FIG. 14 illustrates a polypropylene-overmolded modular plastic mesh part.

### Example 2. Block Injection on One Shot Injection Machine

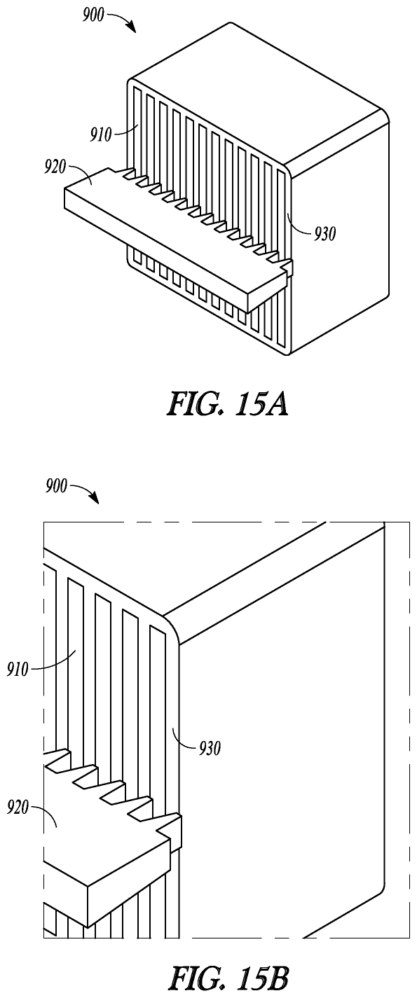

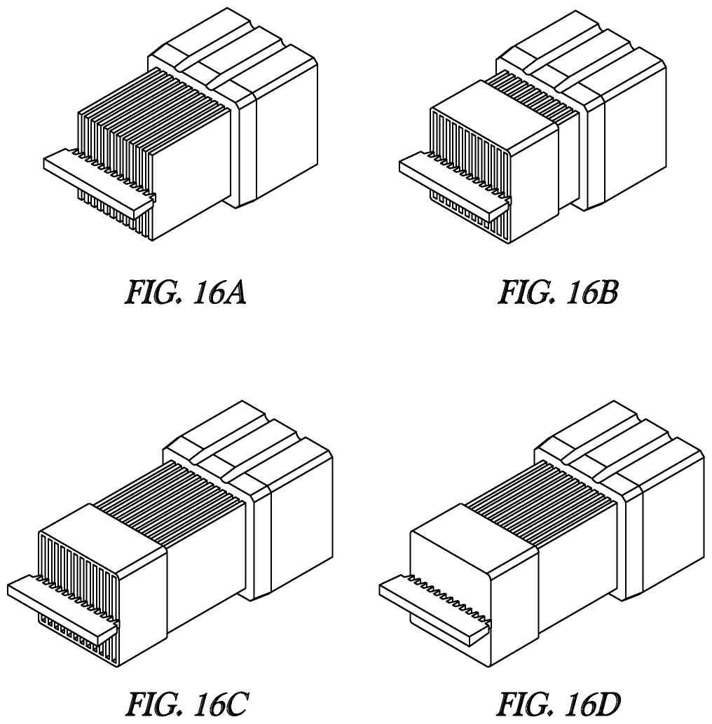

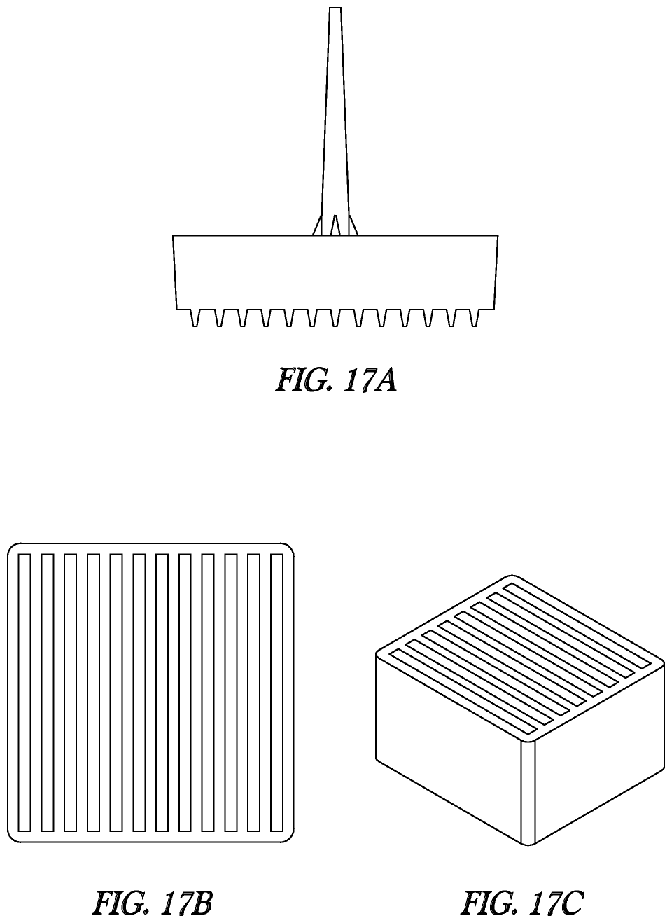

An overlap runner gate system combination with a teeth shaped movable core was used to form a solid block on a normal one shot injection machine. The apparatus used 900 is shown in FIGS. 15A-B, with the core shown as 910, the runner shown as 920, and the solidified first shot shown as 930. The runner and overlap gate were shared for the first and the second shot melt injection. Before the first shot, the gate overlapped with the cavity and metal teeth of the core. Before the second shot, the gate overlapped with the wall of the first part and the cavity which released by teeth shaped core extraction. One block processing cycle started with the mold open, a hydraulic system pushed the teeth shaped movable core forward, and then the mold was closed and the gate overlapped with mold core teeth and the cavity. The melt was injected into the cavity. After packing and cooling, the mold was opened, and the hydraulic system drew the mold core back, leaving the half block part behind. The mold was then closed and the gate overlapped with the first half block's wall and the cavity that was released by the mold core, and melt was injected into the cavity. After packing and cooling, the mold was opened and the block was ejected, as shown in FIGS. 16A-D. FIG. 16A illustrates a mold ready condition. FIG. 16B illustrates a first shot injection. FIG. 16C illustrates mold core retraction. FIG. 16D illustrates second shot injection. The runner, overlap gate, the first half block, and the final block are shown in FIGS. 17A-C.

The mechanism of adhesion of the layers to one other included partial melting of the surface layer of the last shot with melting caused by the injected hot melt. Higher melt and mold temperatures, and higher injection pressure and packing pressure, are beneficial for a higher layer adhesion strength. In order to maximally enhance the layer adhesion strength, the barrel temperature can be set at the upper limit of recommended barrel temperature setting.

LEXAN™ resin LUX9616G was the plastic used. The injection machine was a Sumitomo SE130DUZ-HP. The screw diameter was 28 mm. The desiccant dryer was a Kawata TV-15. The pre-dry temperature was 120° C., with a drying time of 4 hours. The dew point was −40° C. Barrel temperature settings were (nozzle to hopper) 290° C., 300° C., 290° C., 270° C., and 60° C. The injection speed was 200 mm/min. The injection pressure was 1800 bar. The switch over point was 15 mm. The hold on pressure was 1000 bar. The hold on time was 10 s. The cushion was 6.5 mm. The dosage metering stroke was 60 mm. The decompression was 3 mm. The screw rotate speed was 120 rpm. The back pressure was 10 bar. The cooking time was 30-80 s. The total cycle time was 45 min. The layer thickness was 2.5 mm/layer.

### Example 3. Mechanical Testing of Block of Example 2, and of Blocks Formed from Additional Materials

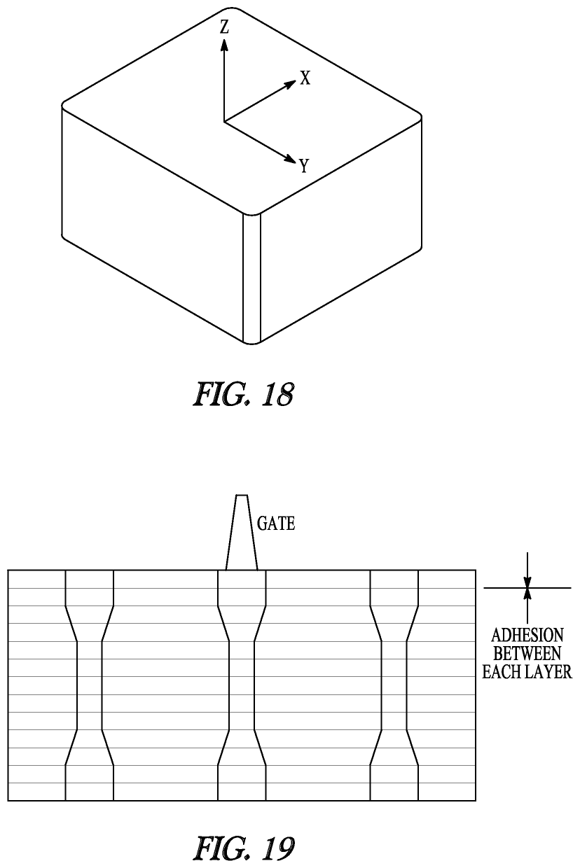

The adhesion strength between layers was of interest. The x and y direction, as shown in FIG. 18, were the melt flow direction, so the mechanical properties in these two directions were not of great interest (it is strong enough like other injection parts). However, the mechanical properties in z direction was of interest, as its strength reflected the adhesion strength between layers and generally indicated whether the blocks' overall mechanical properties were strong or poor.

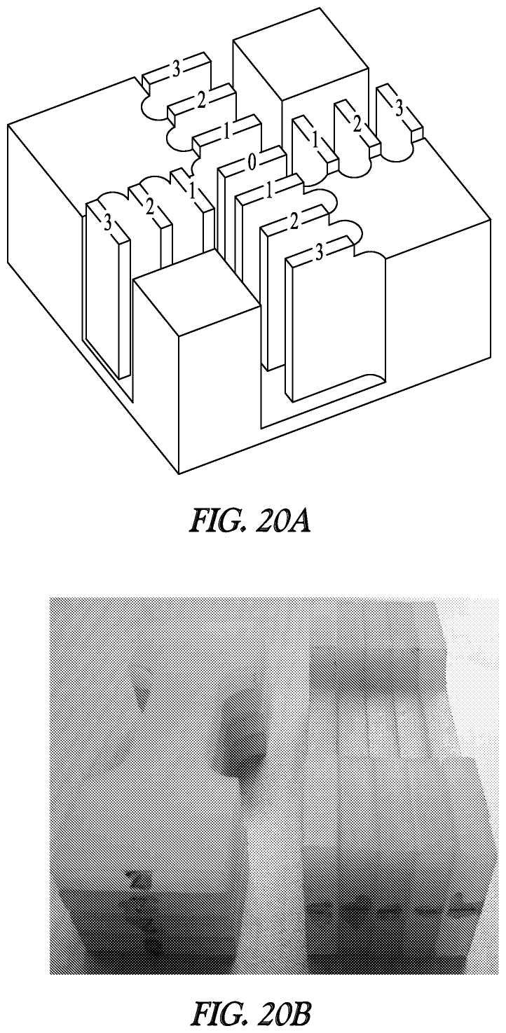

In order to test the layer adhesion strength, a test bar was cut from the block cross layers, as shown in FIG. 19. Because of the thickness of block was 65 mm, it was not possible to cut the test bars in the dimensions as defined in ISO 527 and ASTM 638. However, a small test bar was defined according to ISO 527 type 1A with narrow portion width of 10.0±0.2 mm, a thickness of 4.0±0.2 mm, and a total length of 60 mm. The 3D model was built to cut the rectangular plate to a size of 65 mm×20 mm×4 mm. Then the test bars were cut, as shown in FIGS. 20A-B, with the number (e.g., 0, 1, 2, 3) indicating the test bar's position in the block, with 0 in center, then 1 and 2, with 3 at the edge, to track whether the layer adhesion strength was related to the position within the block or not.

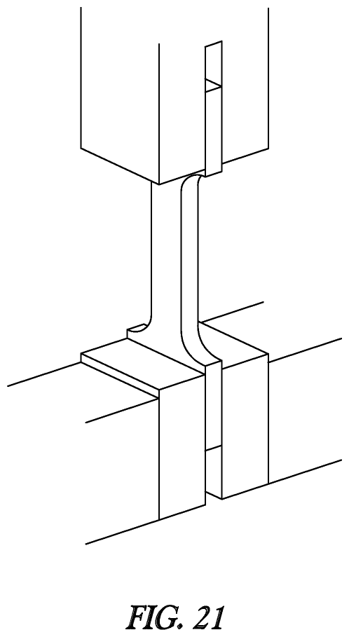

The test on the block parts was performed according to the standard of ISO 527. The test apparatus including a test bar is shown in FIG. 21. The tester was SANS CMT4000 universal testing machine. The test speed was 5 mm/min. One to five test samples were used to determine each data point. The original scan distance was 15 mm.

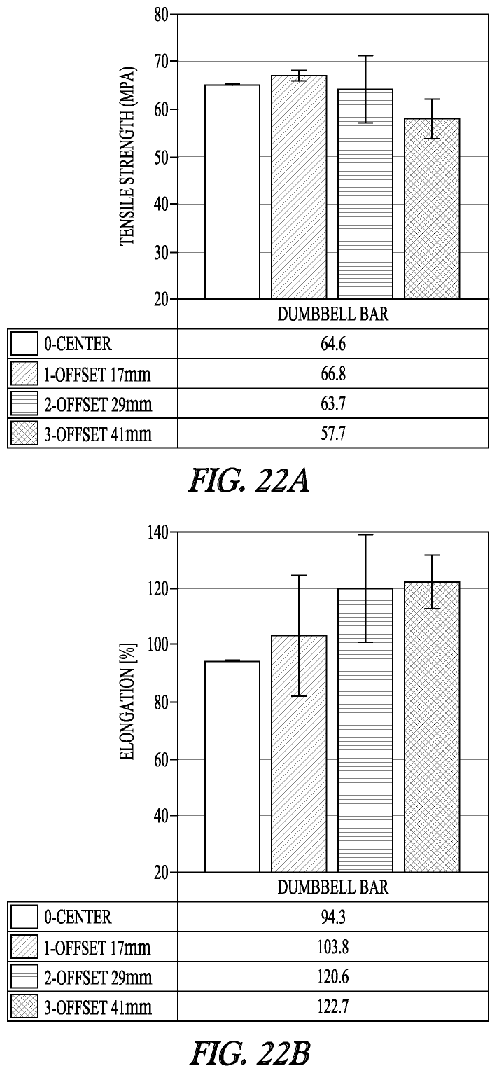

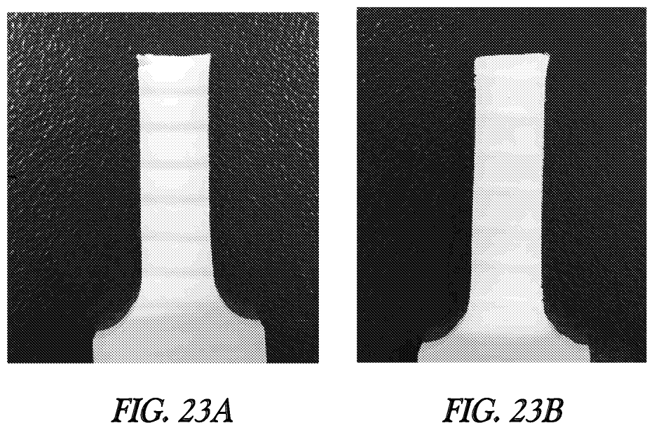

The test results are shown in FIGS. 22A-B. The adhesion strength between layers was about 60 MPa, which was very close to the value of the ISO 527 standard data sheet of 62 MPa with a test speed of 50 mm/minute. The layer adhesion strength was not same from center to the edge. It firstly increased and then reduced gradually. It was not the highest at point No. 0 potentially because of higher residue stress at the gate area, while the highest adhesion strength occurred at No. 1 point, then it reduced gradually further away from the gate. The elongation was more than 90% and increased from center to the edge. There was a clear yield point during testing, which was slightly greater than 120%. The results indicated that the layer adhesion strength was as strong as the resin itself, and there is no evidence to prove that the weakest point occurred at the layer connect area, because while some bars broke at the layer connect area, others broke at non-layer connect areas, as shown in FIGS. 23A-B.

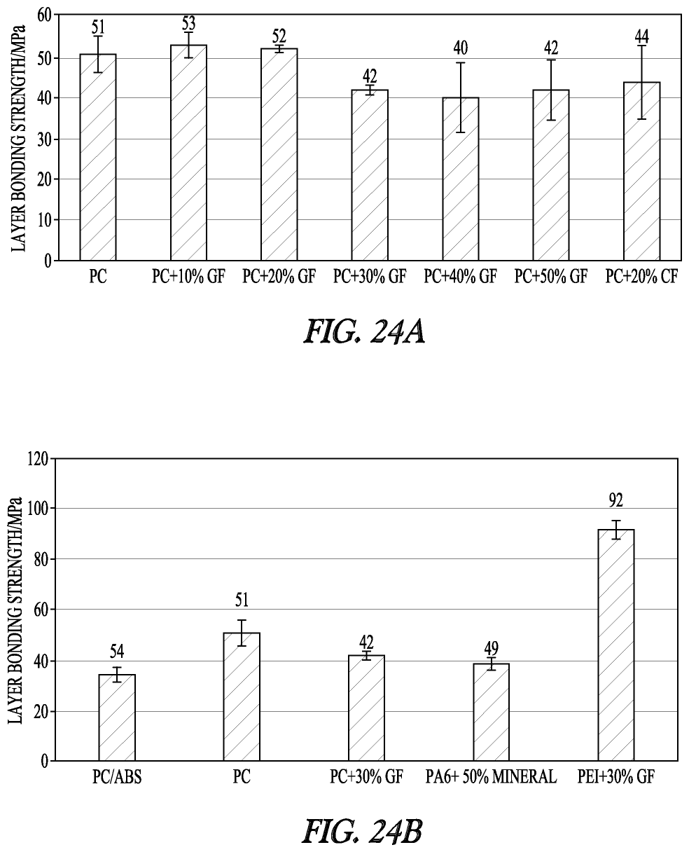

Example 2 was repeated, using pure polycarbonate (LEXAN® HFD 1830), polycarbonate having various amounts of glass fibers therein (10%, 20%, 30%, 40%, and 50% E-glass fibers, these were LNP™ THERMOCOMP™ Compound D151 (10% GF)/D251 (20% GF)/351(30% GF)/D451 (40% GF)/D551 (50% GF)), polycarbonate having 20% carbon fibers therein (PAN-based carbon fibers), a polycarbonate/ABS blend (about 70:30 weight ratio), polyamide 6 including 50% mineral filler (about 2:3 Al₂O₃:talc), and PEI. The resulting blocks were then subjected to tensile strength testing according to ISO 527, using a SANS CMT4000 universal testing machine. Blocks having varying distance from the gate were made—no significant difference in tensile strength was found based on distance from the gate, demonstrating that the block parts could be used for part machining with robust mechanical performance. The test results are shown in FIGS. 24A-B. For polycarbonate base plastics, the layer bonding strength increased slightly when the glass fiber fill level at 0% to 20%. For higher fill levels the layer bonding strength remained at about 80% comparison with pure polycarbonate resin with the glass fiber fill level at 30% to 50% and for carbon fiber (20%) filled polycarbonate resin. PC/ABS, PA6 and PEI also showed robust layer bonding strength.

### Example 4. Prototyping

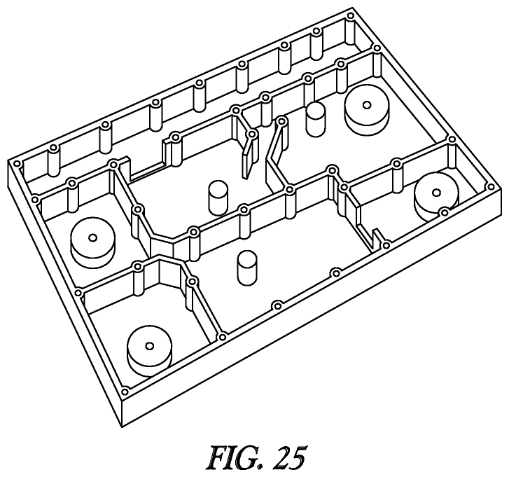

The block formed in Example 2 was used inserted into a CNC cutting machine, which cut out areas of the block to leave behind a prototype Ultem RF-filter part, as shown in FIG. 25.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Exemplary Aspects.

The following Aspects are provided, the numbering of which is not to be construed as designating levels of importance:

Aspect 1 provides a method of injection molding or compression molding an article, the method comprising:

directing a shot of molten material into a mold cavity comprising a plurality of contacting substantially identical modular mesh parts to fill the mold cavity; and

solidifying the shot of molten material to form the article comprising the plurality of modular mesh parts and the solidified shot of molten material.

Aspect 2 provides the method of Aspect 1, wherein the molten material comprises a thermoplastic polymer, a thermosetting polymer, an elastomer, or a combination thereof.

Aspect 3 provides the method of any one of Aspects 1-2, wherein the modular mesh part and the molten material have the same or different composition, preferably wherein the interlocking features comprise a peg on one modular mesh part and a hole on an adjacent modular mesh part and/or providing a first modular mesh comprising having interlocking features and aligning it adjacent to a second modular mesh having interlocking features and using the second interlocking features to connect the first modular mesh and the second modular mesh to form the plurality of contacting substantially identical modular mesh parts, preferably further comprising providing one or more additional modular mesh having interlocking features adjacent to the first modular mesh and/or the second modular mesh and using interlocking features to connect the addition modular mesh to form the plurality of contacting substantially identical modular mesh parts, more preferably where the interlocking features are located near (e.g., adjacent to) a periphery of the modular mesh, even more preferably where the interlocking features are located at corner junctions of the modular mesh.

Aspect 4 provides the method of any one of Aspects 1-3, wherein the modular mesh part comprises a thermoplastic polymer, a thermosetting polymer, an elastomer, an injection-molded part, a compression-molded part, a blow-molded part, a thermoformed part, a part made by additive layer manufacturing, a metal, graphite, graphene, a composite, a circuit, or a combination thereof.

Aspect 5 provides the method of any one of Aspects 1-4, wherein the modular mesh part is a modular plastic mesh part.

Aspect 6 provides the method of any one of Aspects 1-5, wherein the article is a block.

Aspect 7 provides the method of any one of Aspects 1-6, wherein the article is a block having a quadrilateral shape, a circular shape, a triangular shape, a hexagonal shape, a star shape, or an irregular polygonal shape when completed.

Aspect 8 provides the method of any one of Aspects 1-7, wherein a temperature of the shot of molten material is sufficient to at least partially melt the modular mesh parts in the mold cavity prior to the solidifying of the shot of molten material.

Aspect 9 provides the method of any one of Aspects 1-8, wherein the size of the mold cavity is adjustable to accommodate different sizes of layers and stacks comprising the plurality of modular mesh parts.

Aspect 10 provides the method of any one of Aspects 1-9, wherein the plurality of modular mesh parts interlock.

Aspect 11 provides the method of any one of Aspects 1-10, wherein the modular mesh parts comprise interlocking features that interlock with corresponding interlocking features on one or more adjacent modular mesh parts.

Aspect 12 provides the method of any one of Aspects 1-11, wherein the modular mesh part is a rectangular-shaped planar grid comprising two substantially parallel opposing major faces, the grid comprising through-holes running orthogonal to the two major faces.

Aspect 13 provides the method of Aspect 12, wherein the through-holes are about 10% to about 90% of a surface area of each of the two major faces.

Aspect 14 provides the method of any one of Aspects 12-13, wherein the modular mesh part is a square-shaped planar grid.

Aspect 15 provides the method of any one of Aspects 12-14, wherein the modular mesh part has a thickness that is approximately 0.1% to about 10% of a length of either edge of the modular mesh part.

Aspect 16 provides the method of any one of Aspects 12-15, wherein the modular mesh part has a thickness that is approximately 1% to about 2% of a length of either edge of the modular mesh part.

Aspect 17 provides the method of any one of Aspects 12-16, wherein the modular mesh part has an edge length of about 10 mm to about 1 m.

Aspect 18 provides the method of any one of Aspects 12-17, wherein the modular mesh part has an edge length of about 50 mm to about 500 mm.

Aspect 19 provides the method of any one of Aspects 1-18, wherein the modular mesh part comprises a grid comprising a first set of parallel struts and a second set of parallel struts, wherein the first and second sets of struts are perpendicular to one another and intersect throughout the modular mesh part at junctions.

Aspect 20 provides the method of Aspect 19, wherein the first and second sets of struts have an approximately uniform shape with a largest cross-sectional dimension that is approximately the same throughout the modular mesh part.

Aspect 21 provides the method of any one of Aspects 19-20, wherein the junctions have an approximately uniform shape with a largest cross-sectional dimension that is approximately the same throughout the modular mesh part.

Aspect 22 provides the method of Aspect 21, wherein junctions at the corners of the modular mesh part further comprise interlocking features.

Aspect 23 provides the method of any one of Aspects 19-22, wherein the junctions have a largest cross-sectional dimension that is about 50% to about 150% of a largest cross-sectional dimension of the struts.

Aspect 24 provides the method of any one of Aspects 19-23, wherein the junctions have a largest cross-sectional dimension that is about the same as a largest cross-sectional dimension of the struts.

Aspect 25 provides the method of any one of Aspects 1-24, wherein the plurality of modular mesh parts form a layer.

Aspect 26 provides the method of Aspect 25, wherein the modular mesh parts in the layer form a discontinuous edge-to-edge connection with each adjacent modular mesh part in the layer.

Aspect 27 provides the method of Aspect 26, wherein the discontinuous edge-to-edge connection between adjacent modular mesh parts in the layer comprises contact between the corners of the adjacent modular mesh parts, wherein adjacent modular mesh parts in the layer are otherwise free of contact with one another.

Aspect 28 provides the method of Aspect 27, wherein the contacting corners of adjacent modular mesh parts in the layer comprise interlocking features.

Aspect 29 provides the method of any one of Aspects 1-28, wherein the plurality of modular mesh parts form a stack.

Aspect 30 provides the method of Aspect 29, wherein the modular mesh parts of a layer of the stack form a discontinuous face-to-face connection with adjacent modular mesh parts of adjacent layers of the stack.

Aspect 31 provides the method of any one of Aspects 29-30, wherein edges of the modular mesh parts of a layer of the stack align with edges of adjacent modular mesh parts of adjacent layers of the stack.

Aspect 32 provides the method of any one of Aspects 29-31, wherein the discontinuous face-to-face connection between the adjacent modular mesh parts in the adjacent layer comprises contact between the corners of the adjacent modular mesh parts, wherein the adjacent modular mesh parts in the adjacent layers are otherwise free of contact with one another.

Aspect 33 provides the method of Aspect 32, wherein the contacting corners of adjacent modular mesh parts in the adjacent layers comprise interlocking features.

Aspect 34 provides the method of any one of Aspects 1-33, further comprising forming the modular mesh part.

Aspect 35 provides the method of Aspect 34, wherein forming comprises injection molding or compression molding or additive layer manufacturing.

Aspect 36 provides the method of any one of Aspects 1-35, further comprising machining the article to form a part.

Aspect 37 provides the part formed by the method of Aspect 36.

Aspect 38 provides the method of Aspect 37, wherein the part is a prototype part, wherein the method is a method of prototyping.

Aspect 39 provides the article formed by the method of any one of Aspects 1-38

Aspect 40 provides a modular plastic mesh part for injection molding or compression molding an article, the modular plastic mesh part comprising:

a thermoplastic polymer, a thermosetting polymer, an elastomer, or a combination thereof, the modular plastic mesh part having a shape comprising
a square-shaped planar grid comprising two substantially parallel opposing major faces;
through-holes running orthogonal to the two major faces;
a first set of parallel struts and a second set of parallel struts, wherein the first and second sets of struts are perpendicular to one another and intersect throughout the modular plastic mesh part at junctions, the first and second sets of struts having an approximately uniform shape with a largest cross-sectional dimension that is approximately the same throughout the modular plastic mesh part, the junctions having an approximately uniform shape with a largest cross-sectional dimension that is approximately the same throughout the modular plastic mesh part,
the junctions having a largest cross-sectional dimension that is about 50% to about 150% of a largest cross-sectional dimension of the struts; and
the junctions at the corners of the modular plastic mesh part further comprising interlocking features that are sufficient to interlock with corresponding interlocking features on one or more adjacent ones of the modular plastic mesh part in a layer or stack of the modular plastic mesh parts.

Aspect 41 provides an injection-molded or compression-molded block comprising:

the modular plastic mesh part of Aspect 40; and

a solidified material encasing the modular plastic mesh part.

Aspect 42 provides the injection-molded or compression-molded block of Aspect 41, wherein the solidified material encasing the modular plastic mesh part has the same composition as the modular plastic mesh part.

Aspect 43 provides a machined part formed from the injection-molded or compression-molded block of any one of Aspects 41-42.

Aspect 44 provides a method of forming a part, comprising:

forming a block comprising at least one shot of molten material solidified in contact with another solidified material using an injection molding or compression molding technique; and

machining the block to form the part.

Aspect 45 provides the method of Aspect 44, wherein the molten material comprises a thermoplastic polymer, a thermosetting polymer, or an elastomer.

Aspect 46 provides the method of any one of Aspects 44-45, wherein the molten material and the solidified material have the same composition.

Aspect 47 provides the method of any one of Aspects 44-46, wherein forming the block comprises: extruding rods of molten material, allowing the rods to solidify, and cutting the rods; assembling the solid rods on a plate; mounting the rods on the plate in a mold cavity; overmolding molten material around the rods and allowing the molten material to solidify, to form the block.

Aspect 48 provides the method of any one of Aspects 44-47, wherein the block comprises multiple solidified layers.

Aspect 49 provides the method of Aspect 48, wherein the multiple solidified layers are a stack having a thickness of 60 mm or more.

Aspect 50 provides the method of any one of Aspects 44-49, wherein forming the block comprises:

directing a shot of molten material into a mold cavity;

solidifying the shot of molten material, to form a first layer;

enlarging the size of the mold cavity;

directing a second shot of molten material into the mold cavity;

solidifying the second shot of molten material, to form a second layer stacked on the first layer; and

optionally repeating the method to form a stack having more than two layers.

Aspect 51 provides the method of Aspect 50, wherein enlarging the size of the mold cavity comprises removing spacer pads to allow a movable core that is at least one side of the mold cavity to move.

Aspect 52 provides the method of any one of Aspects 50-51, wherein enlarging the size of the mold cavity comprises moving a wedge to allow a movable core that is at least one side of the mold cavity to move.

Aspect 53 provides the method of Aspect 52, wherein the wedge comprises steps that correspond with and mate to steps on the movable core.

Aspect 54 provides the method of any one of Aspects 52-53, wherein the wedge comprises a smooth surface that corresponds with and mates with a smooth surface on the movable core.

Aspect 55 provides the method of any one of Aspects 50-54, wherein enlarging the size of the mold cavity occurs as the second shot of molten material is directed into the mold cavity.

Aspect 56 provides the method of any one of Aspects 44-55, wherein forming the block comprises: directing a shot of molten material into a mold cavity comprising a plurality of contacting substantially identical modular plastic mesh parts to fill the mold cavity; and solidifying the shot of molten material to form the article comprising the plurality of modular plastic mesh parts and the solidified shot of molten material.

Aspect 57 provides the method of any one of Aspects 44-56, wherein forming the block comprises: providing an injection molding or compression molding machine that comprises a melt source of molten material, a mold defining a mold cavity, one or more gates in fluid communication with the melt source and the mold cavity, wherein the one or more gates collectively define a total orifice area, and a mold core movable relative to the one or more gates; directing a first shot of molten material into the mold cavity through a first portion of the total orifice area while simultaneously occluding a second portion of the total orifice area with the mold core; solidifying the first shot of molten material to form a first part of the block; directing the mold core away from the one or more gates after the first part has been formed; directing a second shot of molten material into the mold cavity through the second portion of the total orifice area while simultaneously occluding the first portion of the total orifice area with the first part of the block; and solidifying the second shot of molten material to form a second part of the block.

Aspect 58 provides the method of Aspect 57, further comprising directing the mold core towards the one or more gates to occlude the second portion of the total orifice area and before directing a first shot of molten material into the mold cavity.

Aspect 59 provides the method of Aspect 58, wherein occluding the second portion of the total orifice area with the mold core comprises contacting and occluding half of each of the one or more gates with the mold core.

Aspect 60 provides the method of any one of Aspects 58-59, wherein occluding the second portion of the total orifice area with the mold core comprises contacting and completely occluding half of the one or more gates with the mold core.

Aspect 61 provides the method of any one of Aspects 57-60, wherein the first part of the block remains stationary relative to the one or more gates while the mold core is directed away from the one or more gates after the first part has been formed.

Aspect 62 provides the method of any one of Aspects 57-61, wherein the mold core defines at least a portion of the mold cavity.

Aspect 63 provides the method of any one of Aspects 57-62, wherein the mold core is reusable.

Aspect 64 provides the method of any one of Aspects 57-63, wherein the mold core has a shape that includes a plurality of prongs with parallel opposing surfaces.

Aspect 65 provides the method of Aspect 64, wherein the first shot of molten material is directed between the prongs while the prongs are simultaneously occluding the second portion of the total orifice area.

Aspect 66 provides the method of Aspect 65, wherein the second shot of molten material is directed into a space in the mold cavity previously occupied by the prongs of the mold core when the first shot of molten material was directed into the mold cavity.

Aspect 67 provides the method of any one of Aspects 57-66, wherein the injection molding or compression molding machine further comprises a runner in fluid communication with the melt source and at least some of the one or more gates.

Aspect 68 provides the method of Aspect 67, wherein all of the one or more gates are in fluid communication with the runner.

Aspect 69 provides the method of any one of Aspects 57-68, wherein forming the second part of the block completes the article.

Aspect 70 provides the method of any one of Aspects 57-69, wherein the block has a quadrilateral shape, a circular shape, a triangular shape, a hexagonal shape, a star shape, or an irregular polygonal shape when completed.

Aspect 71 provides the method of any one of Aspects 57-70, wherein the injection molding or compression molding machine is a one-shot injection machine.

Aspect 72 provides the method of any one of Aspects 44-71, wherein forming the block comprises: providing an injection molding or compression molding machine that comprises a melt source of molten material, a mold defining a mold cavity, one or more gates in fluid communication with the melt source and the mold cavity, wherein the one or more gates collectively define a total orifice area, and a mold core movable relative to the one or more gates, wherein the mold core comprises a plurality of prongs with parallel opposing surfaces; contacting the one or more gates with the prongs of the mold core to occlude a first portion of the total orifice area, wherein the prongs of the mold core at least partially define a first shot space along the parallel opposing surfaces of the prongs and wherein the prongs occupy a second shot space; directing a first shot of molten material into the first shot space; solidifying the first shot of molten material to form a first part of the block occupying the first shot space; directing the prongs of the mold core away from the one or more gates to remove the prongs from the second shot space after the first part is formed, wherein the first part at least partially defines the second shot space; directing a second shot of molten material into the second shot space while the first part contacts the one or more gates and occludes a second portion of the total orifice area; and solidifying the second shot of molten material to form a second part of the block.

Aspect 73 provides the part formed by the method of any one of Aspects 44-72.

Aspect 74 provides a method of forming a part, comprising: forming a block, comprising directing a shot of molten material into a mold cavity comprising a plurality of contacting substantially identical modular plastic mesh parts to fill the mold cavity; and solidifying the shot of molten material to form the article comprising the plurality of modular plastic mesh parts and the solidified shot of molten material; and machining the block to form the part.

Aspect 75 provides a method of forming a part, comprising: forming a block, comprising providing an injection molding or compression molding machine that comprises a melt source of molten material, a mold defining a mold cavity, one or more gates in fluid communication with the melt source and the mold cavity, wherein the one or more gates collectively define a total orifice area, and a mold core movable relative to the one or more gates; directing a first shot of molten material into the mold cavity through a first portion of the total orifice area while simultaneously occluding a second portion of the total orifice area with the mold core; solidifying the first shot of molten material to form a first part of the block; directing the mold core away from the one or more gates after the first part has been formed; directing a second shot of molten material into the mold cavity through the second portion of the total orifice area while simultaneously occluding the first portion of the total orifice area with the first part of the block; and solidifying the second shot of molten material to form a second part of the block; and machining the block to form the part.

Aspect 76 provides the method, article, modular mesh part, injection-molded or compression-molded block, or part of any one or any combination of Aspects 1-75 optionally configured such that all elements or options recited are available to use or select from.

Aspect 77 provides the method of any one of Aspects 1-75, wherein the modular plastic mesh part is free of fibers.

Aspect 78 provides the method of any one of Aspects 1-75, wherein the modular plastic mesh part comprises at least one of a thermoplastic polymer, a thermosetting polymer, an elastomer, and is free of fibers.

1. A method of injection molding or compression molding an article, the method comprising:
directing a shot of molten material into a mold cavity comprising a plurality of contacting substantially identical modular mesh parts to fill the mold cavity; and
solidifying the shot of molten material to form the article comprising the plurality of modular mesh parts and the solidified shot of molten material.

2. The method of claim 1, wherein the molten material comprises a thermoplastic polymer, a thermosetting polymer, an elastomer, or a combination thereof.

3. The method of claim 1, wherein the modular mesh part comprises a thermoplastic polymer, a thermosetting polymer, an elastomer, an injection-molded part, a compression-molded part, a blow-molded part, a thermoformed part, a part made by additive layer manufacturing, a metal, graphite, graphene, a composite, a circuit, or a combination thereof.

4. The method of claim 1, wherein the modular mesh parts comprise interlocking features that interlock with corresponding interlocking features on one or more adjacent modular mesh parts.

5. The method of claim 4, wherein the interlocking features comprise a peg on one modular mesh part and a hole on an adjacent modular mesh part.

6. The method of claim 1, comprising providing a first modular mesh comprising having interlocking features and aligning it adjacent to a second modular mesh having interlocking features and using the second interlocking features to connect the first modular mesh and the second modular mesh to form the plurality of contacting substantially identical modular mesh parts.

7. The method of claim 6, further comprising providing one or more additional modular mesh having interlocking features adjacent to the first modular mesh and/or the second modular mesh and using interlocking features to connect the addition modular mesh to form the plurality of contacting substantially identical modular mesh parts.

8. The method of claim 4, where the interlocking features are located near a periphery of the modular mesh.

9. The method of claim 4, where the interlocking features are located at corner junctions of the modular mesh.

10. The method of claim 1, wherein the modular mesh part is a rectangular-shaped planar grid comprising two substantially parallel opposing major faces, the grid comprising through-holes running orthogonal to the two major faces, the grid comprising a first set of parallel struts and a second set of parallel struts, wherein the first and second sets of struts are perpendicular to one another and intersect throughout the modular mesh part at junctions.

11. The method of claim 1, wherein the plurality of modular mesh parts form a layer, wherein the modular mesh parts in the layer form a discontinuous edge-to-edge connection with each adjacent modular mesh part in the layer, wherein the discontinuous edge-to-edge connection between adjacent modular mesh parts in the layer comprises contact between the corners of the adjacent modular mesh parts, wherein adjacent modular mesh parts in the layer are otherwise free of contact with one another.

12. The method of claim 1, wherein the plurality of modular mesh parts form a stack, wherein the modular mesh parts of a layer of the stack form a discontinuous face-to-face connection with adjacent modular mesh parts of adjacent layers of the stack, wherein the discontinuous face-to-face connection between the adjacent modular mesh parts in the adjacent layer comprises contact between the corners of the adjacent modular mesh parts, wherein the adjacent modular mesh parts in the adjacent layers are otherwise free of contact with one another.

13. The method of claim 1, further comprising machining the article to form a part.

14. The part formed by the method of claim 13.

15. An article formed by the method of claim 1.

16. A modular plastic mesh part for injection molding or compression molding an article, the modular plastic mesh part comprising:
a thermoplastic polymer, a thermosetting polymer, an elastomer, or a combination thereof, the modular plastic mesh part having a shape comprising
a square-shaped planar grid comprising two substantially parallel opposing major faces;
through-holes running orthogonal to the two major faces;
a first set of parallel struts and a second set of parallel struts, wherein the first and second sets of struts are perpendicular to one another and intersect throughout the modular plastic mesh part at junctions, the first and second sets of struts having an approximately uniform shape with a largest cross-sectional dimension that is approximately the same throughout the modular plastic mesh part, the junctions having an approximately uniform shape with a largest cross-sectional dimension that is approximately the same throughout the modular plastic mesh part,
the junctions having a largest cross-sectional dimension that is about 50% to about 150% of a largest cross-sectional dimension of the struts; and
the junctions at the corners of the modular plastic mesh part further comprising interlocking features that are sufficient to interlock with corresponding interlocking features on one or more adjacent ones of the modular plastic mesh part in a layer or stack of the modular plastic mesh parts.

17. The mesh of claim 16, wherein the interlocking features comprise pegs and holes.

18. An injection-molded or compression-molded block comprising:
the modular plastic mesh part of claim 16; and
a solidified material encasing the modular plastic mesh part.

19. A machined part formed from the injection-molded or compression-molded block of claim 18.
